(19) United States
(12) Patent Application Publication
(10) Pub. No.: US 2024/0018798 A1
(43) Pub. Date: Jan. 18, 2024

(54) POST MOUNTING ASSEMBLY AND METHOD FOR MOUNTING A POST TO A GROUND SURFACE USING THE SAME

(71) Applicant: 9220-6820 Québec Inc., Dorval (CA)

(72) Inventor: William Kell WARSHAW, Montréal, Québec (CA)

(21) Appl. No.: 18/038,898

(22) PCT Filed: Nov. 26, 2021
(86) PCT No.: PCT/CA2021/051694

§ 371 Date: May 25, 2023

Related U.S. Application Data
(60) Provisional application No. 63/118,811, filed on Nov. 27, 2020.

(51) Int. Cl. E04H 12/22

(52) U.S. Cl. CPC E04H 12/2284; E04H 17/22

(57) ABSTRACT

A post mounting assembly for mounting a post to a ground surface, the post mounting assembly comprising: a ground-securing member securable to the ground surface and having an inner surface at least partially delimiting an internal securing member cavity; and an inclination-adjusting member mountable to the post, the inclination-adjusting member comprising at least one inclination limiting portion receivable in the internal securing member cavity, the inclination-adjusting member being selectively engageable with the ground securing member such that the ground securing member and the inclination adjusting member are configured together in at least one inclined configuration in which the post is inclined with respect to a direction perpendicular to the ground surface at a corresponding inclination, the at least one inclination limiting portion abutting the inner surface of the ground securing member when the ground securing member and the inclination adjusting member are configured in one of the at least one inclined configuration to maintain the post at the corresponding inclination relative to the ground surface.

### TECHNICAL FIELD

The technical field relates to post mounting assemblies, and more particularly to assemblies to mount posts or other similar elements to a ground surface in an inclined orientation and to methods for securing a post to a ground surface.

### BACKGROUND

Structures such as handrails, traffic signs, fences and the like may be supported by one or more posts secured to a ground surface.

A number of various mounting assemblies and techniques may be used to secure each post to the ground surface. Unfortunately, existing mounting assemblies and techniques usually only permit the mounting of a post to a ground surface in a substantially perpendicular orientation with respect to the ground surface. Such assemblies are thus non satisfactory when the ground surface is inclined with horizontal, or in situations in which it would be desirable to mount the post to the ground surface at an angle relative to the ground surface.

Furthermore, existing mounting assemblies and technique may be relatively complex, labour intensive, time consuming and/or may not be appropriated to allow a user to easily and substantially precisely angle the post at a desired angle.

There is therefore a need for a post mounting assembly which would be able to overcome or at least minimize some of the above-identified drawbacks.

### SUMMARY

According to one aspect, there is provided a post mounting assembly for mounting a post to a ground surface, the post mounting assembly comprising: a ground-securing member securable to the ground surface and having an inner surface at least partially delimiting an internal securing member cavity; and an inclination-adjusting member mountable to the post, the inclination-adjusting member comprising at least one inclination limiting portion receivable in the internal securing member cavity, the inclination-adjusting member being selectively engageable with the ground securing member such that the ground securing member and the inclination adjusting member are configured together in at least one inclined configuration in which the post is inclined with respect to a direction perpendicular to the ground surface at a corresponding inclination, the at least one inclination limiting portion abutting the inner surface of the ground securing member when the ground securing member and the inclination adjusting member are configured in one of the at least one inclined configuration to maintain the post at the corresponding inclination relative to the ground surface.

In at least one embodiment, the at least one inclined configuration includes a plurality of inclined configurations, each inclined configuration corresponding to an inclination relative to the ground surface.

In at least one embodiment, the ground securing member comprises at least one inner angular coupling portion located on the inner surface thereof and wherein the inclination-adjusting member comprises an outer surface with at least one outer angular coupling portion, the inner and outer angular coupling portions being engageable with each other in at least one angular position when the ground securing member and the inclination adjusting member are configured together in said at least one inclined configuration.

In at least one embodiment, the at least one inner angular coupling portion includes two inner angular coupling portions and the at least one outer angular coupling portion includes two outer angular coupling portions.

In at least one embodiment, the two inner angular coupling portions are located diametrically opposite each other on the ground-securing member and wherein the two outer angular coupling portions are located diametrically opposite each other on the inclination-adjusting member.

In at least one embodiment, each inner angular coupling portion comprises a plurality of teeth members and wherein each outer angular coupling portion comprises a plurality of coupling grooves for receiving a corresponding plurality of the teeth members.

In at least one embodiment, the teeth members are elongated and extend in a fanned-out configuration such that the teeth members substantially converge towards each other from a lower end of the teeth members towards an upper end of the teeth members.

In at least one embodiment, the teeth members are substantially evenly spaced from each other.

In at least one embodiment, all the teeth members are angled at a same angle relative to adjacent teeth members.

In at least one embodiment, all the teeth members are angled at an angle of about 2.4° relative to each other.

In at least one embodiment, the plurality of teeth members includes a number of teeth members and the plurality of coupling grooves includes a number of coupling grooves, the number of teeth members being less than the number of coupling grooves.

In at least one embodiment, plurality of teeth members includes three teeth members and where the plurality of coupling grooves includes nine teeth members.

In at least one embodiment, the plurality of teeth members and the plurality of coupling grooves are configured to allow the post to be inclined at an inclination angle of between about 7.2° and −7.2°.

In at least one embodiment, the ground-securing member further comprises at least one guiding slot formed in the inner surface and wherein the inclination-adjusting member further comprises at least one alignment tab, each alignment tab being receivable in a corresponding one of the at least one guiding slots.

In at least one embodiment, the at least one guiding slot includes two guiding slots and the at least one alignment tab includes two alignment tabs.

In at least one embodiment, the two guiding slots are positioned substantially diametrically opposite each other on the ground-securing member and wherein the two alignment tabs are positioned substantially diametrically opposite each other on the inclination-adjusting member.

In at least one embodiment, each guiding slot extends along substantially an entirety of a height of the ground-securing member.

In at least one embodiment, each alignment tab extends along substantially an entirety of a height of the inclination-adjusting member.

In at least one embodiment, each guiding slot is at least partially delimited by two guiding walls extending from the inner surface of the ground-securing member inwardly into the internal securing member cavity and extending substantially parallel to each other.

In at least one embodiment, each inner angular coupling portion includes a coupling portion outer face that is inclined relative to a central axis of the inclination-adjusting member such that a bottom end of the coupling portion outer face is located at a greater distance from the central axis than a top end of the coupling portion outer face.

In at least one embodiment, the coupling portion outer face is angled away from the central axis at an angle of between about 10° and about 30°.

In at least one embodiment, the coupling portion outer face is angled away from the central axis at an angle of about 20°.

In at least one embodiment, the inclination adjusting member is mountable at a post lower portion of the post, the inclination adjusting member including a bottom wall that is substantially curved.

In at least one embodiment, the ground-securing member is made of a single, unitary piece.

In at least one embodiment, the ground-securing member is sized and shaped to entirely cover the inclination-adjusting member when the inclination-adjusting member is received in the ground-securing member.

In at least one embodiment, the inclination-adjusting member comprises first and second base-mounting members connectable to each other to surround at least partially and at least partially enclose the post.

In at least one embodiment, the ground-securing member comprises at least one adjusting pin receiving sleeve protruding inwardly from the inner surface, and wherein the inclination-adjusting member comprises at least one post engaging pin, each post engaging pin having a first end engageable with an outer surface of the post and a second end selectively engageable in a corresponding one of the pin receiving sleeve in at least one linear position when the ground securing member and the inclination adjusting member are configured together in said at least one inclined configuration.

In at least one embodiment, the ground-securing member comprises a ground-securing disc and a cap assembly engageable with the ground-securing disc to set the cap assembly in one of a plurality of angular positions relative to the ground-securing disc.

In at least one embodiment, the ground-securing disc includes a peripheral wall and a plurality of angular couplers extending outwardly from the peripheral wall, and wherein the cap assembly including a plurality of angular couplers extending inwardly into an interior of the cap assembly, the angular couplers of the ground-securing disc and the angular couplers of the cap assembly being sized and shaped to be engaged with each other.

In at least one embodiment, the at least one post engaging pin includes at least one first side post engaging pin for engaging the post on a first side thereof and at least one second side post engaging pin for engaging the post on a second side thereof opposite the first side.

In at least one embodiment, the at least one first side engaging pin includes two first side post engaging pins and the at least one second side engaging pin includes one second side post engaging pin.

In at least one embodiment, all post engaging pins are substantially parallel to each other.

In at least one embodiment, all post engaging pins substantially extend in a common horizontal plane.

In at least one embodiment, each post engaging pin is movable along a longitudinal axis thereof to selectively retract and extend the post engaging pin relative to the corresponding pin-receiving sleeve.

In at least one embodiment, each post engaging pin is threaded and is threadably engageable in the corresponding pin-receiving sleeve.

In at least one embodiment, the ground-securing member includes a curved inner face portion and wherein the inclination-adjusting member further comprises an inclination-limiting ring mountable to a post end portion of the post, the inclination-limiting ring being receivable in the curved inner face portion and having a curved outer face conforming with the curved inner face portion.

In at least one embodiment, the inclination-limiting ring has a corrugated inner surface.

In at least one embodiment, the ground-securing member comprises a ground-facing side, an opposed post-facing side and at least one inner angular coupling portion arranged on the post-facing side, and further wherein the inclination-adjusting member comprises an outer surface with an outer angular coupling portion formed thereon, the inner and outer angular coupling portions being engageable with each other in at least one angular configuration when the ground securing member and the inclination adjusting member are configured together in said at least one inclined configuration.

In at least one embodiment, the ground-securing member comprises a ground-securing disc and a cap assembly engageable with the ground-securing disc to set the cap assembly in one of a plurality of angular positions relative to the ground-securing disc.

In at least one embodiment, the ground-securing disc includes a peripheral wall and a plurality of angular couplers extending outwardly from the peripheral wall, and wherein the cap assembly including a plurality of angular couplers extending inwardly into an interior of the cap assembly, the angular couplers of the ground-securing disc and the angular couplers of the cap assembly being sized and shaped to be engaged with each other.

In at least one embodiment, the outer angular coupling portion includes at least one pivot-limiting tooth and wherein the inner angular coupling portion includes at least one corresponding pivot-limiting tooth engageable with the at least one pivot-limiting tooth of the outer angular coupling portion.

In at least one embodiment, the inclination-adjusting member comprises a post bottom cap snuggly engageable within a post end portion of the post.

In at least one embodiment, the outer angular coupling portion and the inner angular coupling portion are similarly curved convexly.

In at least one embodiment, the ground securing member includes an elongated slot and wherein the inclination-adjusting member includes an inclination-limiting fastener slidably engageable in the elongated slot.

According to another aspect, there is also provided a support assembly for supporting a structure above a ground surface, the support assembly comprising: a post; and a post mounting assembly as defined hereinabove.

According to yet another aspect, there is also provided a method for securing a post to a ground surface in an inclined configuration, the method comprising: providing an inclination adjusting member engageable with a post end portion of the post and comprising at least one inclination limiting portion; providing a ground securing member having an inner surface at least partially delimiting an internal securing member cavity; securing the ground-securing member to the ground surface; engaging the inclination adjusting member with the ground securing member in an inclined configuration in which the post is inclined with respect to a direction perpendicular to the ground surface and the inclination adjusting member is at least partially received in the internal securing member cavity, wherein said at least one inclination-limiting portion abuts against the inner surface of the ground-securing member to maintain an inclination of the post with respect to the ground surface.

### BRIEF DESCRIPTION OF THE DRAWINGS

FIG. 1 is a top perspective view of a post mounting assembly, in accordance with one embodiment, with a post engaging the post mounting assembly;

FIG. 2 is a bottom perspective view of the post mounting assembly illustrated in FIG. 1;

FIG. 3 a top perspective view, partially exploded, of the post mounting assembly illustrated in FIG. 1;

FIG. 4 is a bottom perspective view, partially exploded, of the post mounting assembly illustrated in FIG. 1;

FIG. 5 is a bottom perspective view of a ground securing member of the post mounting assembly illustrated in FIG. 1;

FIG. 6A is a side perspective view, partially exploded, of the post mounting assembly illustrated in FIG. 1, with the post engaging an inclination adjusting member of the post mounting assembly and with a portion of the ground securing member removed to better show the interior of the ground securing member;

FIG. 6B is a side elevational view of an inclination adjusting member of the post mounting assembly illustrated in FIG. 1;

FIG. 6C is a partially sectioned perspective view of the post mounting assembly illustrated in FIG. 1, with the ground securing member and the inclination adjusting member configured in a first inclined configuration;

FIG. 6D is an enlarged portion of the post mounting assembly illustrated in FIG. 6C, showing details of the engagement between the ground securing member and the inclination adjusting member when in the first inclined configuration;

FIG. 6E is a partially sectioned perspective view of the post mounting assembly illustrated in FIG. 1, with the ground securing member and the inclination adjusting member configured in a second inclined configuration in which an inclination angle of the post is greater than in the first inclined configuration;

FIG. 6F is an enlarged portion of the post mounting assembly illustrated in FIG. 6E, showing details of the engagement between the ground securing member and the inclination adjusting member when in the second inclined configuration;

FIG. 6G is a partially sectioned perspective view of the post mounting assembly illustrated in FIG. 1, with the ground securing member and the inclination adjusting member configured in a third inclined configuration in which an inclination angle of the post is greater than in the first inclined configuration and less than in the second inclined configuration;

FIG. 6H is an enlarged portion of the post mounting assembly illustrated in FIG. 6G, showing details of the engagement between the ground securing member and the inclination adjusting member when in the third inclined configuration;

FIG. 7 is a front elevation view of the post mounting assembly illustrated in FIG. 1, with the post mounting assembly configured in the first inclined configuration;

FIG. 8 is a longitudinal cross-sectional view of the post mounting assembly taken along cross-section line A-A of FIG. 7, with the post mounting assembly configured in the first inclined configuration;

FIG. 9 is a side elevation view of the post mounting assembly of FIG. 1, with the post mounting assembly configured in the first inclined configuration;

FIG. 10 is a longitudinal cross-sectional view of the post mounting assembly taken along lines B-B of FIG. 9;

FIG. 11 is a transversal cross-sectional view of the post mounting assembly taken along cross-section line C-C of FIG. 9;

FIG. 12 is a transversal cross-sectional view of the post mounting assembly taken along cross-section line D-D of FIG. 9;

FIG. 13 is a top perspective view, partially exploded, of a post mounting assembly, in accordance with another embodiment, with a post engaging the post mounting assembly;

FIG. 14 is a bottom perspective view, partially exploded, of the post mounting assembly illustrated in FIG. 13;

FIG. 15 is a side perspective view of a cap member of a ground-securing member for the post mounting assembly illustrated in FIG. 13;

FIG. 16 is a top perspective view of the post mounting assembly illustrated in FIG. 13, with the post removed;

FIG. 17 is a side elevation view of the ground-securing member illustrated in FIG. 13;

FIG. 18A is a cross-sectional view of the ground-securing member of the post mounting assembly taken along cross-section line E-E of FIG. 17;

FIG. 18B is a cross-sectional view of the post mounting assembly of FIG. 13, with the ground securing member and the inclination adjusting member configured in a first inclined configuration;

FIG. 19 is a top perspective view, exploded, of a post and a post mounting assembly, in accordance with another embodiment;

FIG. 20 is a side elevation view of the post mounting assembly illustrated in FIG. 19;

FIG. 21 is a longitudinal cross-sectional view of the post mounting assembly taken along lines A-A of FIG. 20; and

FIG. 22 is a perspective transversal cross-sectional view of a post mounting assembly, in accordance with yet another embodiment.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only.

Moreover, it will be appreciated that positional descriptions such as “above”, “below”, “forward”, “rearward”, “left”, “right” and the like should, unless otherwise indicated, be taken in the context of the figures only and should not be considered limiting. Moreover, the figures are meant to be illustrative of certain characteristics of the post mounting assembly and components thereof and are not necessarily to scale.

To provide a more concise description, some of the quantitative expressions given herein may be qualified with the term “about”. It will be understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the following description, an embodiment is an example or implementation. The various appearances of “one embodiment”, “an embodiment” or “some embodiments” do not necessarily all refer to the same embodiments. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments.

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional elements. It is to be understood that where the claims or specification refer to “a” or “an” element, such reference is not to be construed that there is only one of that element. It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. It will be appreciated that the methods described herein may be performed in the described order, or in any suitable order.

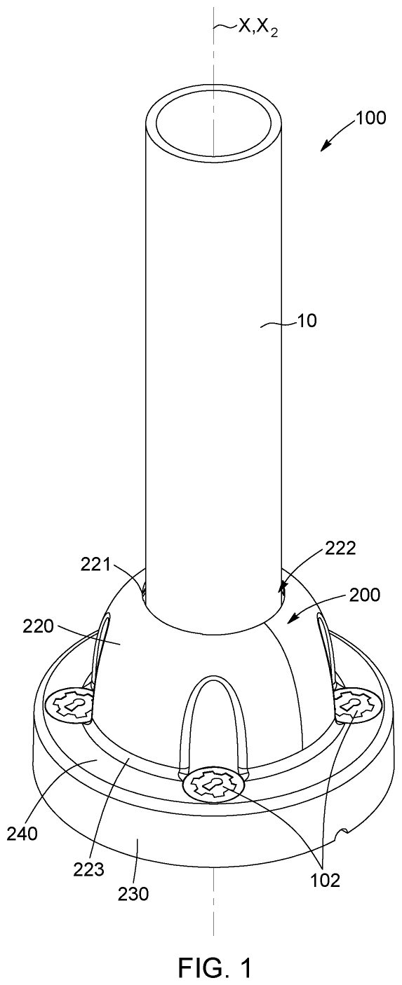

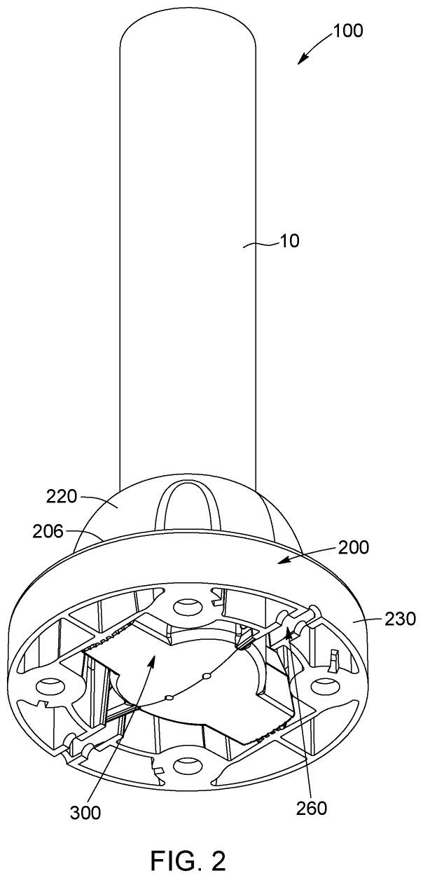

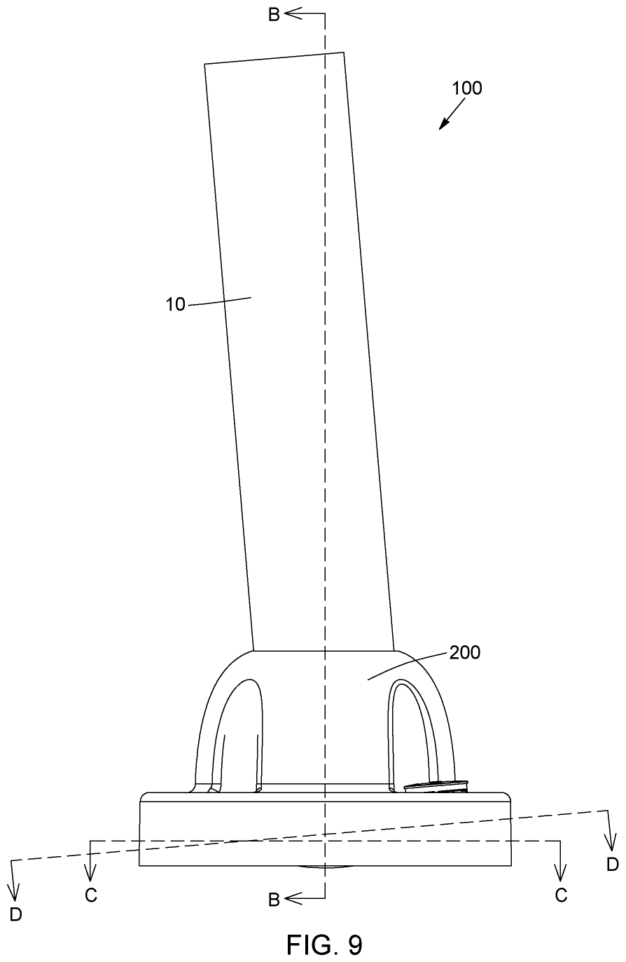

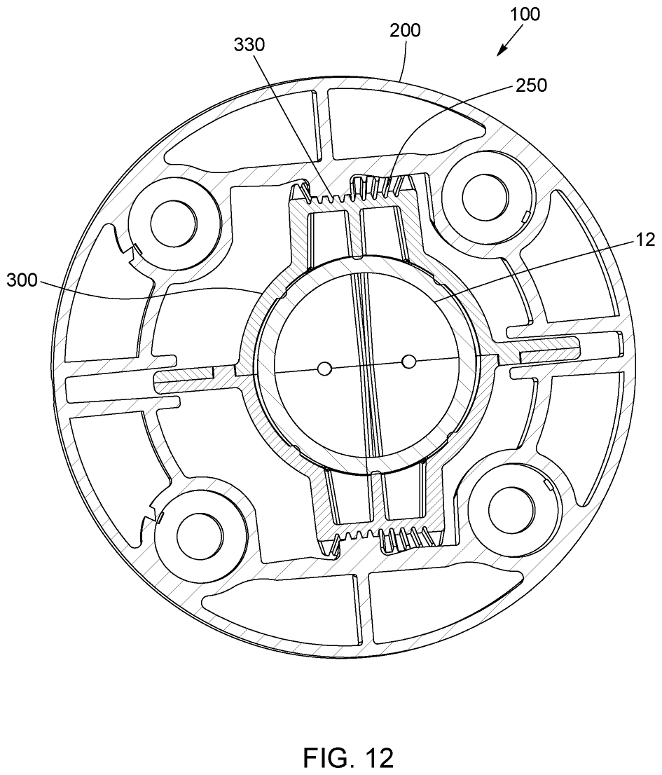

Referring to FIGS. 1 to 12, there is shown a post mounting assembly 100, in accordance with one embodiment.

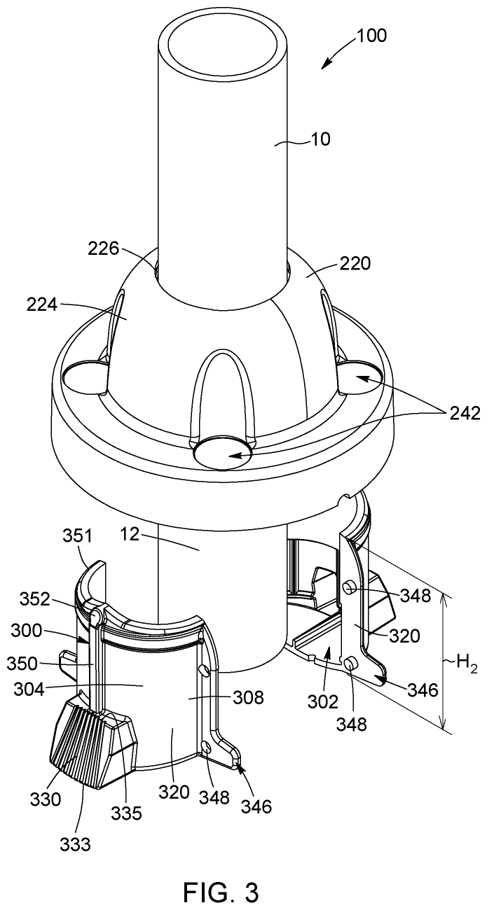

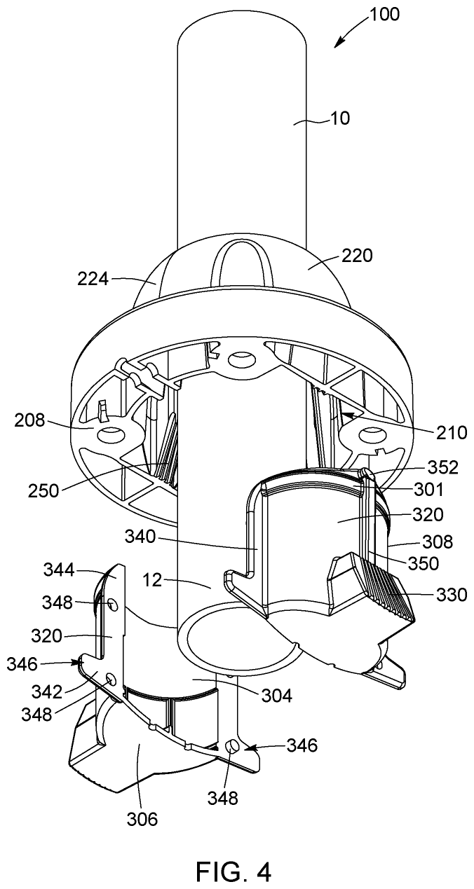

The post mounting assembly 100 is configured to mount a post 10 to a ground surface. The post 10 could be, for instance and without being limitative, a handrail post to secure a handrail assembly to the ground surface. It could also be a traffic sign post, a fence post, a post for holding up a billboard or the like. The post 10 is substantially elongated and extends along a longitudinal axis X. The post mounting assembly 100 is configured to engage a post end portion 12 of the post 10, best shown in FIGS. 3 and 4, and maintain the post 10 in at least one angled or inclined position relative to a ground surface, i.e. in a position wherein the post 10 is inclined with respect to a direction perpendicular to the ground surface, or in other words, in a position wherein the longitudinal axis X of the post 10 is not perpendicular to the ground surface.

In the embodiment illustrated in FIGS. 1 to 12, the post mounting assembly 100 comprises a ground-securing member 200 securable to the ground surface and an inclination-adjusting member 300 engageable with the ground-securing member 200. In the illustrated embodiment, the inclination-adjusting member 300 is mountable to the post end portion 12 of the post 10. Alternatively, the inclination-adjusting member 300 could instead be part of the post end portion 12 and integrally formed with the post 10.

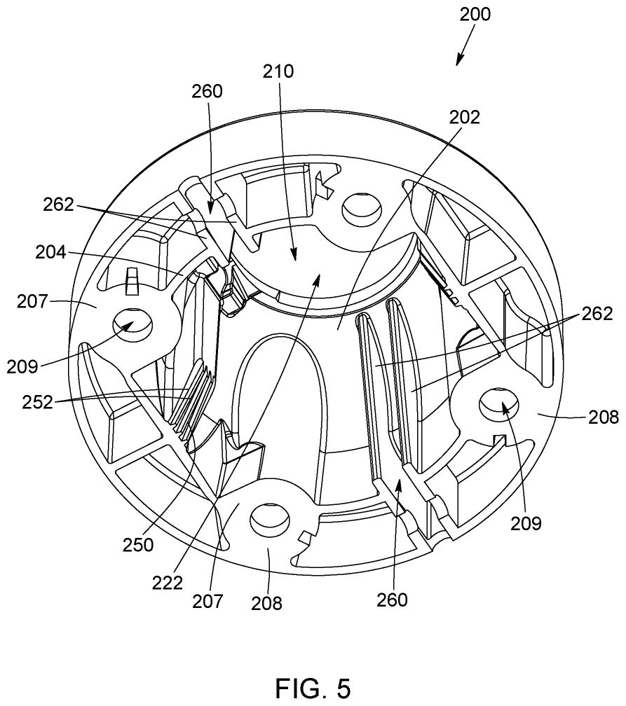

The ground-securing member 200 and the inclination-adjusting member 300 are selectively configurable together in at least one inclined configuration (in a plurality thereof, in the embodiment shown) in which the post 10 is inclined with respect to the direction perpendicular to the ground surface. Specifically, in the illustrated embodiment, the ground-securing member 200 is hollow and has an inner surface 202, shown in FIG. 5, and an internal securing member cavity 210 at least partially delimited by the inner surface 202, while the inclination-adjusting member 300 comprises at least one inclination-limiting portion 310 which is abuttable with the inner surface 202. More particularly, in the embodiment shown, the inclination-adjusting member 300 includes a plurality of inclination-limiting portions 310, each inclination-limiting portion 310 being abuttable with the inner surface 202 to maintain the post 10 at a certain angle corresponding to the inclination-limiting portion 310 relative to the ground surface.

As best shown in FIGS. 1, 3, 7 and 8, the ground-securing member 200 is generally bell-shaped and comprises an upper portion 220 extending between upper and lower ends 221, 223 and a ground-contacting lower portion 230 located at the lower end 221, with the upper portion 220 tapering from the lower end 223 towards the upper end 221. In the illustrated embodiment, the ground-securing member 200 extends around a central axis X₁. The upper portion 220 has a post-receiving opening 222 formed therein which communicates with the internal securing member cavity 210. In the illustrated embodiment shown, the post-receiving opening 222 is positioned such that the central axis X₁ extends through a center of the post-receiving opening 222. Still in illustrated embodiment, the post-receiving opening 222 is substantially circular to receive the substantially cylindrical post end portion 12 of the post 10. Alternatively, the post-receiving opening 222 could be substantially rectangular to receive a substantially rectangular post end portion of the post 10 or have any other shape which conforms to a shape of the post end portion 12. In another embodiment, the post-receiving opening 222 could be sufficiently large to receive the post end portion 12 but may not conform to the shape of the post end portion 12.

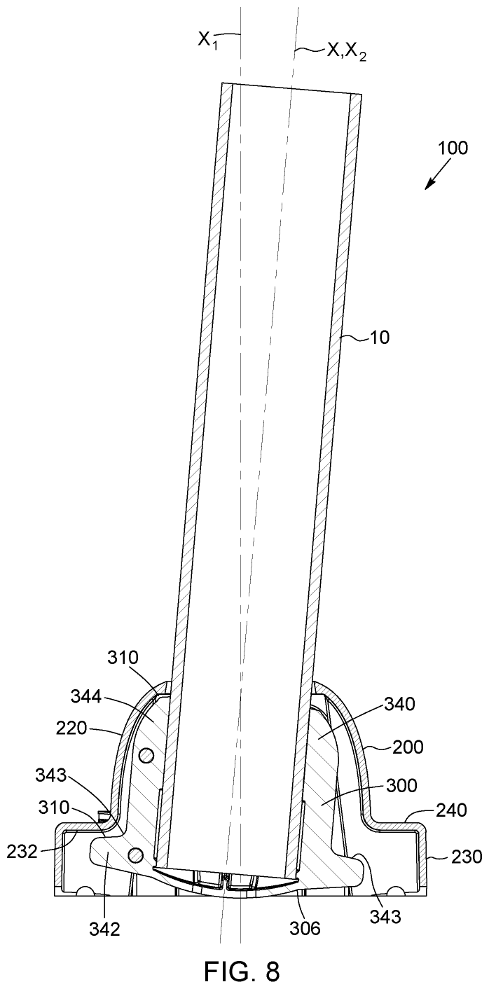

The upper portion 222 further comprises a peripheral wall 224 partially delimiting the internal securing member cavity 210. As shown in FIG. 3, the peripheral wall 224 includes an upper edge 226 which borders the post-receiving opening 222. As best shown in the cross-sectional view of FIG. 8, the upper edge 226 substantially tapers as the upper edge 226 extends upwardly from the internal securing member cavity 210 towards an exterior of the ground-securing member 200 to prevent interference with the post end portion 12 when the post 10 is angled according to different inclination angles, as will be explained further below.

Still in the illustrated embodiment, when viewed in a cross-sectional plane containing the central axis X₁ as shown in FIG. 8, the internal securing member cavity 210 delimited by the upper portion 220 has a cross-section that increases along the central axis X₁ from the upper portion 220 towards the lower portion 230. In other words, the internal securing member cavity 210 has a first diameter towards the upper end 221 and has a second diameter towards the lower end 223 which is greater than the first diameter.

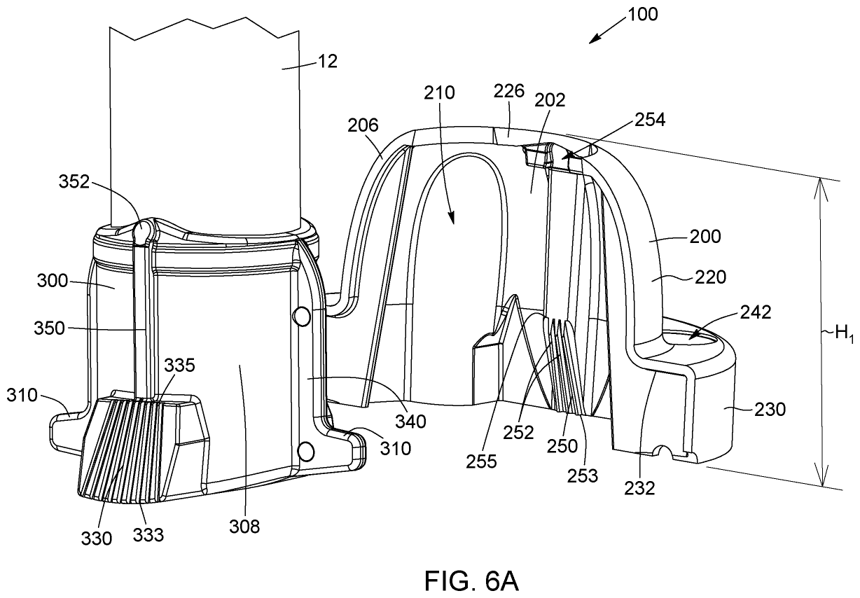

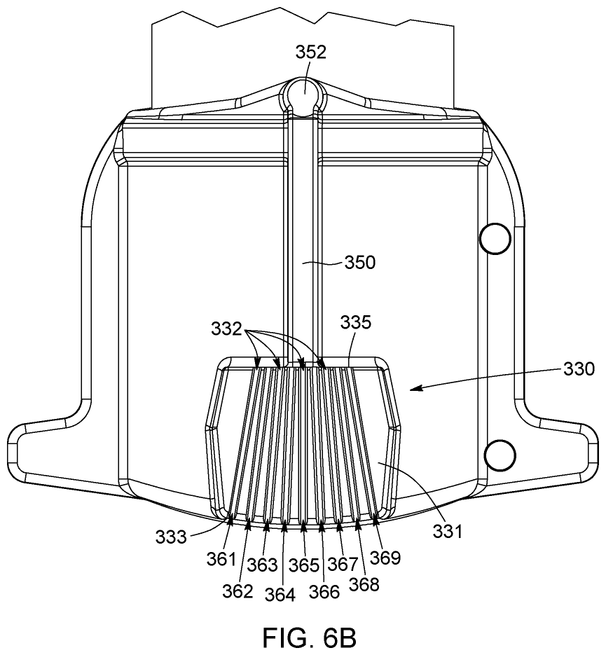

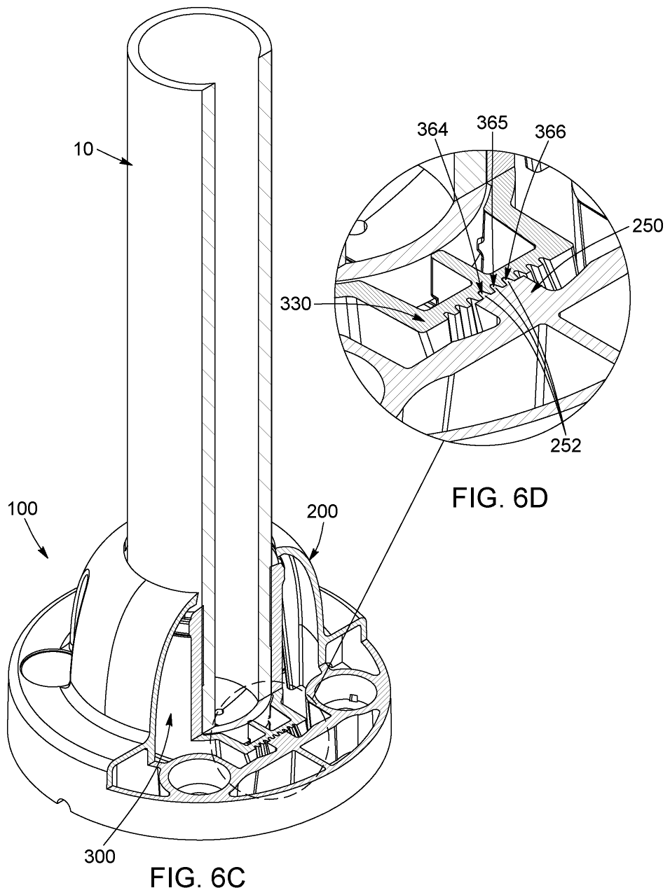

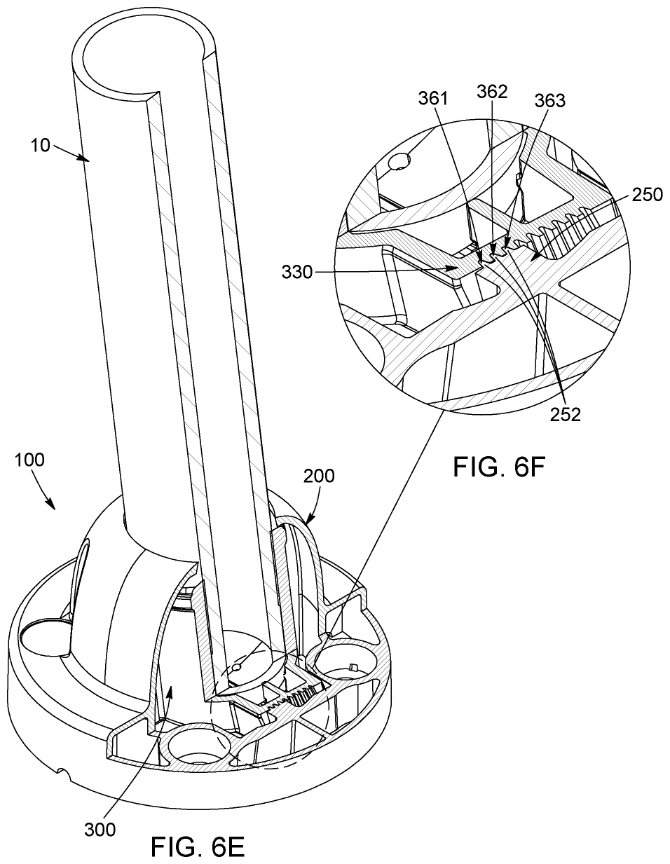

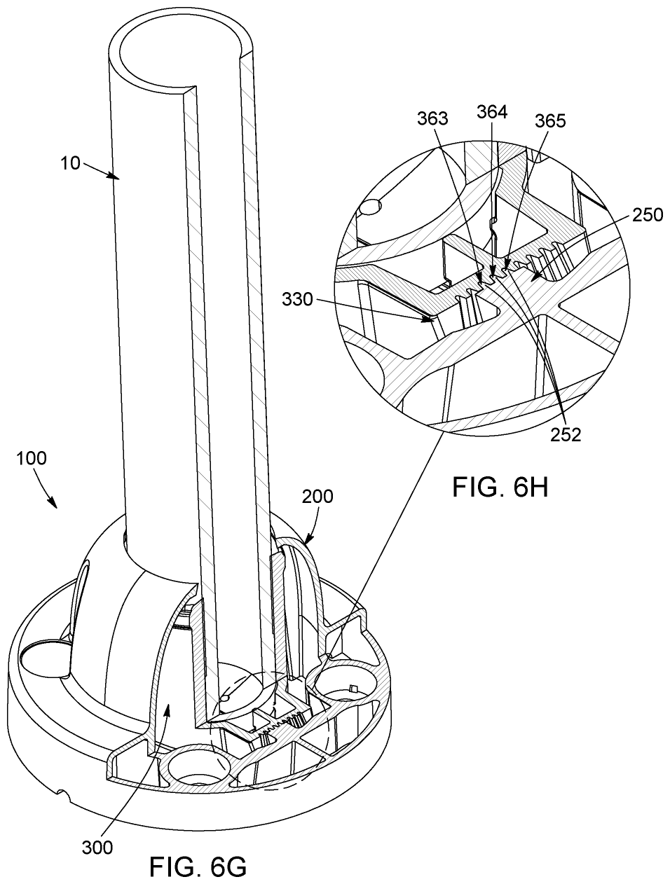

In the illustrated embodiment, the lower portion 230 is substantially cylindrical and has an axis which coincides with the central axis X₁ of the ground-securing member 200. The lower portion 230 is also substantially wider than the upper portion 220. Specifically, the lower ground-contacting portion 230 further has a third diameter which is larger than the second diameter of the lower end 223. The inner surface 202 of the ground-securing member 200 thereby forms a peripheral inclination-limiting shoulder 232, best shown in FIGS. 6 and 8, at a junction of the inner surfaces of the upper and lower portions 220, 230.

As best shown in FIG. 1, the ground-securing member 200 comprises an annular intermediate face 240 located opposite the peripheral inclination-limiting shoulder 232 and forming a junction between the upper and lower portions 220, 230. In the illustrated embodiment, the intermediate face 240 is substantially planar and extends in a plane substantially transversal to the central axis X₁ of the ground-securing member 200. In the illustrated embodiment, the intermediate face 240 is substantially perpendicular to the central axis X₁ but alternatively, the intermediate face 240 could be angled at a different angle relative to the central axis X₁.

In the illustrated embodiment, the intermediate face 240 includes a plurality of fastener-receiving openings 242 sized and shaped to receive securing fasteners such as anchor bolts and the like to secure the post mounting assembly 100 to the ground surface. Specifically, in the illustrated embodiment, the plurality of fastener-receiving openings 242 includes four fastener-receiving openings 242. Alternatively, the plurality of fastener-receiving openings 242 could include more or less than four fastener-receiving openings 242. In another embodiment, the plurality of fastener-receiving openings 242 may not be defined in the intermediate face 240 and may be defined in another surface of the ground-securing member 200. In yet another embodiment, the ground-securing member 200 may not include fastener-receiving openings and may be securable to the ground surface using another suitable securing technique.

In the illustrated embodiment, the ground-securing member 200 comprises at least one inner angular coupling portion 250 configured for coupling to a corresponding portion of the inclination-adjusting member 300. Specifically, in the illustrated embodiment, the ground-securing member 200 comprises two inner angular coupling portions 250 protruding inwardly from the inner surface 202 and positioned substantially diametrically opposite each other. Alternatively, the ground-securing member 200 could include a single inner angular coupling portion or more than two inner angular coupling portions 250, and the inner angular coupling portions 250 could be evenly spaced from each other around the central axis X₁ or could be disposed according to any suitable pattern.

Still in the illustrated embodiment, the inner angular coupling portions 250 are located on the lower portion 230 of the ground-securing member 200. Alternatively, the inner angular coupling portions 250 could extend partially on the lower portion 230 and partially on the upper portion 220, or the inner angular coupling portions 250 could be located only on the upper portion 220. In yet another embodiment, one or more of the inner angular coupling portions 250 could be located on at least partially on the lower portion 230 and the other ones of the inner angular coupling portions 250 could be located on the upper portion 220.

As best shown in FIGS. 5 and 6A, each inner angular coupling portion 250 comprises a plurality of teeth members 252 which are configured to selectively engage the inclination-adjusting member 300 into one of multiple configurations, each configuration defining a corresponding inclination of the post 10 relative to the ground surface. In the embodiment illustrated in FIGS. 1 to 12, the teeth members 252 are elongated and extend in a fanned-out configuration such that the teeth members 252 substantially converge towards each other from a lower end 253 of the teeth members 252 towards an upper end 255 of the teeth members 252. In the illustrated embodiment, the teeth members 252 are further substantially evenly spaced from each other and all the teeth members 252 are angled at the same angle relative to adjacent teeth members 252. Alternatively, the teeth members 252 could instead be spaced unevenly from each other and/or could be angled at different angles relative to adjacent teeth members 252.

Still in the illustrated embodiment, as best shown in FIGS. 6B to 6E, the plurality of teeth members 252 includes three teeth members 252 but alternatively, the plurality of teeth members 252 could include more or less than three teeth members 252.

In the illustrated embodiment, the teeth members 252 are inclined (i.e. non-parallel) relative to the central axis X₁ of the ground-securing member 200, as best shown in FIG. 6A. Specifically, the teeth members 252 are angled away from the central axis X₁ such that the lower end 253 of the teeth members 252 is located at a greater distance from the central axis X₁ than the upper end 255 of the teeth members 252. In one embodiment, the teeth members 252 are angled away from the central axis X₁ at an angle comprised between about 10° and about 30°. For instance, the teeth members 252 are angled away from the central axis X₁ at an angle of about 20°. Alternatively, the teeth members 252 could instead be angled away from central axis X₁ at another angle, or even be substantially parallel to the central axis X₁.

As best shown in FIG. 5, the ground-securing member 200 further comprises at least one guiding slot 260 formed in the inner surface 202. The guiding slots 260 are adapted to receive a corresponding portion of the inclination-adjusting member 300 to guide the inclination-adjusting member 300 relative to the ground-securing member 200 along a predetermined path when the inclination-adjusting member 300 is moved from one angular configuration to another angular configuration relative to the ground-securing member 200.

Specifically, in the illustrated embodiment, the ground-securing member 200 includes two guiding slots 260 which are positioned substantially diametrically opposite each other. In the illustrated embodiment, the two guiding slots 260 are further offset angularly from the inner angular coupling portion 250 around the central axis X₁ by about 90 degrees. In other words, the inner angular coupling portion 250 are located in a first vertical plane intersecting the central axis X₁ and the two guiding slots 260 are located in a second vertical plane intersecting the central axis X₁ and extending perpendicular to the first vertical plane. Alternatively, the ground-securing member 200 could include a single guiding slot or more than two guiding slots 260, and the guiding slots 260 could be evenly spaced from each other around the central axis X₁ or could be disposed according to any suitable pattern.

In the illustrated embodiment, each guiding slot 260 extends along substantially an entirety of a height H₁ of the ground-securing member 200, i.e. extends substantially on the inner surface 202 in both the lower and upper portions 230, 220 of the ground-securing member 200. Alternatively, the guiding slots 260 could instead extend along only the upper or lower portions 220, 230, or partially along the upper and/or lower portion 220, 230.

In the embodiment shown, each guiding slot 260 is at least partially delimited by two guiding walls 262 extending from the inner surface 202 inwardly into the internal securing member cavity 210 and substantially parallel to each other. As best shown in FIG. 5, each guiding slot 260 opens into a ground-securing surface 204 located at the lower end 223 of the ground-securing member 200. Alternatively, each guiding slot 260 could instead have a closed bottom end.

In the illustrated embodiment, the entire ground-securing member 200 is made of a single, unitary piece 206 which defines the upper, intermediate and lower portions of the ground-securing member 200. Alternatively, the ground-securing member 200 could be made of multiple separate portions secured together. For example, the ground securing member 200 could be made of two separate halves which could be brought together and secured together around the post end portion 12 and/or the inclination-adjusting member 300.

In the illustrated embodiment, the ground-securing member 200 comprises at least one fastener-guiding sleeve 208, each fastener guiding sleeve 208 defining a fastener-receiving through hole 209 which extends downwardly from a corresponding fastener-receiving opening 242 of the intermediate face 240. Specifically, in the illustrated embodiment, since the intermediate face 240 includes four fastener-receiving openings 242, the ground-securing member 200 includes four fastener-guiding sleeves 208. Still in the illustrated embodiment, the fastener-guiding sleeve 208 has a ground-contacting side 207 located at the lower end 223 of the ground-securing member 200 and forming at least partially the ground-securing surface 204.

In the illustrated embodiment, the internal securing member cavity 210 is shaped and dimensioned to substantially fully contain the inclination-adjusting member 300 such that the inclination-adjusting member 300 is fully covered by the ground-securing member 200 when received in the internal securing member cavity 210. Alternatively, the inclination-adjusting member 300 could partially extend outwardly from the ground-securing member 200, or could be accessible or at least visible from the exterior of the ground-securing member 200.

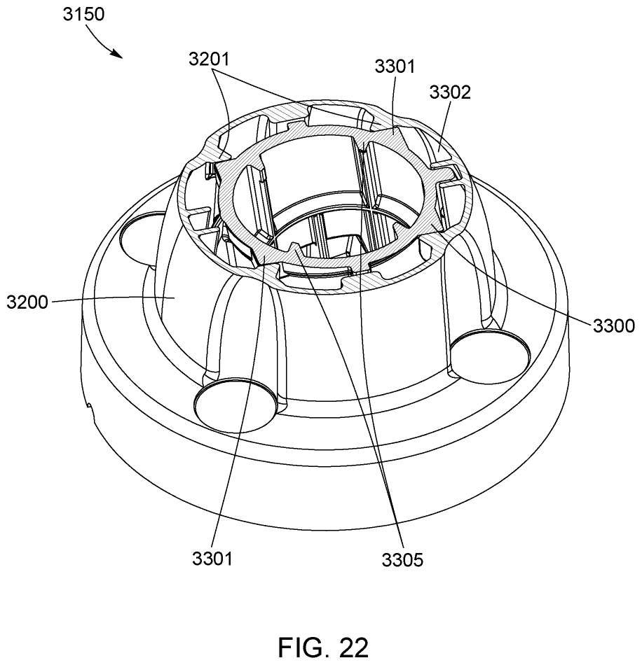

It will be understood that the shape and the configuration of the ground-securing member 200, as well as the shape, the configuration, the relative location and the number of the fastener-receiving openings, the inner angular coupling portions, the guiding slots and the fastener-guiding sleeves thereof can vary from the embodiment shown. For example, FIG. 22 shows a post mounting assembly 3150, in accordance with an alternative embodiment.

In this embodiment, the post mounting assembly 3150 comprises a ground-securing member 3200 which further includes distortion-limiting tabs 3201 (or distortion-limiting ribs 3201) protruding inwardly from the inner surface 3202 thereof (four, in the embodiment shown) extending along substantially an entirety of the height of the ground-securing member 3200 to rigidify the connection between the inclination-adjusting member and the ground-securing member 3200.

Referring back to FIGS. 1 to 12, the inclination-adjusting member 300 comprises first and second base-mounting members 320 connectable to each other to surround at least partially and at least partially enclose the post end portion 12. Alternatively, the inclination-adjusting member 300 could instead be made of a single, unitary piece.

As shown in FIG. 3, the inclination-adjusting member 300 has a central axis X₂ and defines a post-receiving cavity 302 shaped and sized to receive the post end portion 12. In the illustrated embodiment, since the post end portion 12 is substantially cylindrical, the post-receiving cavity 302 is also substantially cylindrical. In the embodiment shown, the inclination-adjusting member 300 comprises a peripheral wall 304 and a ground-contacting surface 306 (or bottom wall 306) at least partially delimiting together the post-receiving cavity 302. The post-receiving cavity 302 opens at an upper part 301 of the inclination-adjusting member 300. The base-receiving cavity 302 is shaped and dimensioned to contain (or receive) at least partially the post end portion 12. When the post end portion 12 is at least partially contained in the post-receiving cavity 302, the central axis X₂ of the inclination-adjusting member 300 substantially coincides with the longitudinal axis X of the post 10.

In the illustrated embodiment, the inclination-adjusting member 300 comprises an outer surface 308 and at least one outer angular coupling portion 330 disposed on the outer surface 308. Specifically, each outer angular coupling portion 330 protrudes outwardly from the outer surface 308 proximal the bottom wall 306. Each outer angular coupling portion 330 is positioned and configured so as to engage a corresponding inner angular coupling portion 250 of the ground-securing member 200 when the inclination-adjusting member 300 is received in the internal securing member cavity 210.

In the illustrated embodiment, the inclination-adjusting member 300 comprises two outer angular coupling portions 330 positioned substantially diametrically opposite each other, each one being engageable with a corresponding one of the two inner angular coupling portions 250 of the ground-securing member 200. More specifically, in the illustrated embodiment, each outer angular coupling portions 330 is formed on the outer surface 308 of a corresponding one of the first and second base-mounting members 320.

As detailed below, each outer angular coupling portion 330 at least partially forms one of the inclination-limiting portions 310 of the inclination-adjusting member 300.

As best shown in FIGS. 3 and 6A to 6H, in the illustrated embodiment, each outer angular coupling portion 330 comprises a coupling portion outer face 331 and a plurality of coupling grooves 332 defined in the coupling portion outer face 331. The coupling grooves 332 are disposed in a fanned-out configuration so as to converge towards each other from a bottom end 333 of the outer angular coupling portion 330 towards an upper end 335 of the outer angular coupling portion 330. As detailed below, the outer angular coupling portion 330 is shaped and dimensioned to engage with a corresponding one of the inner angular coupling portions 250 of the ground-securing member 200. In the illustrated embodiment, each tooth member 252 of the inner angular coupling portion 250 is dimensioned to be received at least partially in one of the coupling grooves 332. The spacing between the teeth members 252 is further substantially similar to the spacing between the coupling grooves 332, and the angle between adjacent coupling grooves 332 is substantially similar to the angle between adjacent teeth members 252. Still in the illustrated embodiment, each outer angular coupling portion 330 comprises more coupling grooves 332 than each inner angular coupling portion 250 comprises teeth members 252. Specifically, each outer angular coupling portion 330 comprises nine coupling grooves 332 (best shown in FIG. 6C) while, as explained above, each inner angular coupling portion 250 comprises three teeth members 252. It will therefore be understood that only a portion of the outer angular coupling portion 330 (i.e. only some of the coupling grooves 332) receive the teeth members 252 when the inner angular coupling portions 250 engage the outer angular coupling portion 330. The inner angular coupling portions 250 will be configured at a certain inclined configuration depending on which coupling grooves 332 are currently receiving the teeth members 252.

For example, in the illustrated embodiment, the coupling grooves 332 include first, second, third, fourth, fifth, sixth, seventh, eighth and ninth grooves 361-369, as shown in FIG. 6B. When the teeth members 252 are received in the fourth, fifth and sixth grooves 364, 365, 366, the outer angular coupling portions 330 and the inner angular coupling portions 250 are configured in a first configuration, shown in FIGS. 6C and 6D, in which the outer angular coupling portions 330 are substantially centered relative to the inner angular coupling portions 250. In this first or vertical configuration, the central axis X₁ of the ground-securing member 200 and the central axis X₂ of the inclination-adjusting member 300 are substantially coaxial with each other, i.e. at an angle of about 0° relative to each other, such that the post 10 extends generally perpendicularly to the ground surface.

The outer angular coupling portions 330 and the inner angular coupling portions 250 could further be engaged in a second configuration, shown in FIGS. 6E and 6F, in which the teeth members 252 instead engage the first, second, third grooves 361, 362, 363. In the embodiment shown, this second configuration would represent a maximum inclination of the central axis X₁ of the ground-securing member 200 relative to the central axis X₂ of the inclination-adjusting member 300, and therefore of the post 10 relative to the ground surface. In the embodiment shown, when in the second configuration, the central axis X₁ of the ground-securing member 200 and the central axis X₂ are inclined or angled relative to each other at an angle of about 7.2°. Alternatively, when in the second configuration, the central axis X₁ of the ground-securing member 200 and the central axis X₂ could be inclined relative to each other at another angle.

In the illustrated embodiment, the outer angular coupling portions 330 and the inner angular coupling portions 250 could further be engaged in a third configuration in which the teeth members 252 instead engage the third, fourth and fifth grooves 363, 364, 365, as shown in FIGS. 6G and 6H. This third configuration would represent an intermediate inclination of the central axis X₁ of the ground-securing member 200 relative to the central axis X₂ of the inclination-adjusting member 300, and therefore of the post 10 relative to the ground surface (i.e. a configuration having an inclination angle comprised between an inclination angle of the second configuration and a substantially null inclination angle of the first configuration).

The outer angular coupling portions 330 and the inner angular coupling portions 250 could also be engaged in fourth and fifth configurations representing an inclination of the central axis X₁ of the ground-securing member 200 relative to the central axis X₂ of the inclination-adjusting member 300 corresponding respectively to the second and third configurations, but on the opposite side compared to the second and third configurations described above.

It will further be understood that in addition to the first to fifth configurations described above, the outer angular coupling portions 330 and the inner angular coupling portions 250 could be engaged together in multiple other intermediate configurations in which the teeth members 252 engage other combinations of grooves 332. In one embodiment, the teeth members 252 could be engageable with the grooves 332 such that the post 10 could be oriented at intermediate inclination angles of about 2.4°, which could make the post 10 vertical if the ground surface is inclined at a 24:1 slope, and of about 4.8°, which would make the post 10 vertical if the ground surface is inclined at a 12:1 slope. Alternatively, the teeth members 252 could be engageable with the grooves 332 such that the post 10 is oriented at any other angle.

In another embodiment, the inner and outer angular coupling portions 250, 330 could be configured in one or more configurations in which only some of the teeth members 252 engage the grooves 332. For example, two of the teeth members 252 could engage the first and second grooves 361, 362 while the other teeth member 252 could be spaced laterally from the first groove 361 without engaging any grooves.

In another embodiment, the spacing between the teeth members 252 may be different from the spacing between the grooves 332. For example, the teeth members 252 could be positioned to be engageable with the third, fifth and seventh grooves 363, 365, 367, or any other combination of the coupling grooves. In yet another embodiment, each inner angular coupling portion 250 could include less than three teeth members (e.g. a single tooth member) or more than three teeth members.

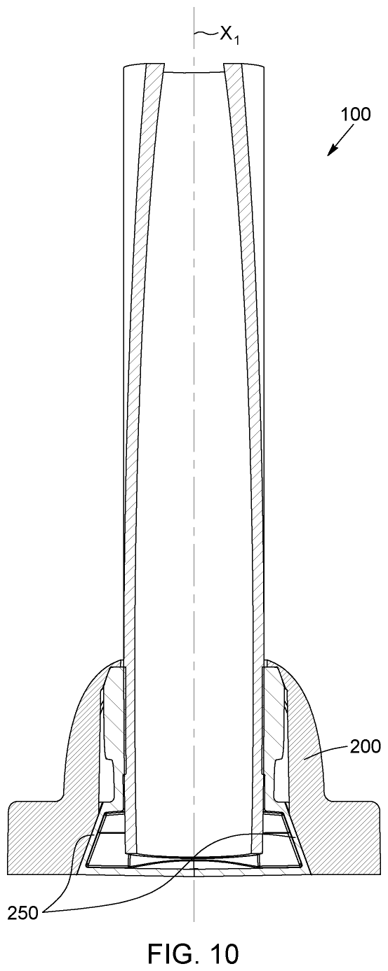

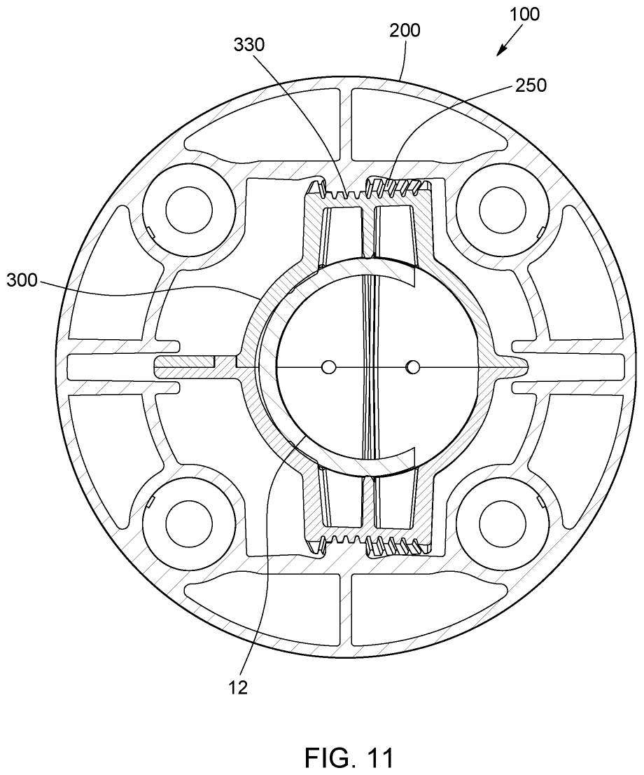

In the illustrated embodiment, the coupling portion outer face 331 is further inclined relative to the central axis X₂ of the inclination-adjusting member 300. As best shown in FIGS. 6A and 10, the coupling portion outer face 331 is angled away from the central axis X₂ such that a bottom end of the coupling portion outer face 331 is located at a greater distance from the central axis X₂ than a top end of the coupling portion outer face 331. Specifically, the coupling portion outer face 331 is angled away from the central axis X₂ at an angle corresponding to the angle of the teeth members 252 relative to the central axis X₁ of the ground-securing member 200. As explained above, in the illustrated embodiment, the teeth members 252 are angled away from the central axis X₁ at an angle comprised between about 10° and about 30°. For instance, the teeth members 252 are angled away from the central axis X₁ at an angle of about 20°. The coupling portion outer face 331 therefore is also angled away from the central axis X₂ at an angle comprised between about 10° and about 30°, for instance of about 20° such that the teeth members 252 extends substantially parallel to the coupling portion outer face 331 when the inclination-adjusting member 300 and the ground-securing member 200 are engaged together in one of the plurality of inclined configurations. Alternatively, the coupling portion outer face 331 could instead be substantially parallel to the central axis X₂.

In the illustrated embodiment, the inclination-adjusting member 300 also comprises at least one alignment tab 340, and more specifically two alignment tabs 340 in the illustrated embodiment, which could be diametrically opposed to each other as shown in FIG. 4. The alignment tabs 340 protrude from the outer surface 308 and extend along substantially an entirety of a height H₂ of the inclination-adjusting member 300. In the illustrated embodiment, the alignment tab 340 is substantially L-shaped and comprises lower and upper portions 342, 344. As illustrated in FIG. 8, when viewed in a plane containing the central axis X₂ of the inclination-adjusting member 300, the upper portion 344 has a cross-section smaller than a cross-section of the lower portion 342. As detailed below, an upper edge 343 of the lower portion 342 at least partially forms one of the inclination-limiting portions 310 of the inclination-adjusting member 300.

In the illustrated embodiment, each one of the first and second base-mounting members 320 of the inclination-adjusting member 300 comprises two alignment tab halves 346. As best shown in FIGS. 3 and 4, each alignment tab half 346 includes mechanical couplers 348 configured to connect corresponding mechanical couplers 348 of a corresponding alignment tab half 346 of the other base-mounting member 320 to thereby form the alignment tabs 340 in addition to securing the two base-mounting members 320 together.

Each alignment tab 340 is shaped and dimensioned to engage (i.e. to be at least partially received in) a corresponding guiding slot 260 of the ground-securing member 200. For instance, in the illustrated embodiment, the alignment tab 340 is configured to be at least partially received between the two guiding walls 262. In the illustrated embodiment, when the first and second members are mechanically coupled to each other, the assembly of two corresponding alignment tabs is shaped and dimensioned to be at least partially received between the two guiding walls 262.

In the illustrated embodiment, considered along a periphery of the inclination-adjusting member 300, each alignment tab 340 is arranged between the two outer angular coupling portions 330. In the illustrated embodiment, the alignment tabs 340 define a first plane containing the central axis X₂ of the inclination-adjusting member 300 (and the longitudinal axis X of the post 10 when the inclination-adjusting member 300 is mounted thereto or when the inclination-adjusting member is part of the post end portion 12).

The inclination-adjusting member 300 further comprises at least one inclination-adjusting ridge 350, and more specifically two inclination-adjusting ridges 350 in the illustrated embodiment, protruding outwardly from the outer surface 308 of the inclination-adjusting member 300. In the illustrated embodiment, each inclination-adjusting ridge 350 extends upwardly from the upper end 335 of a corresponding outer angular coupling portion 330 towards an upper end 351 of the inclination-adjusting member 300. As shown in FIGS. 3 and 6A, the inclination-adjusting ridge 350 includes an upper end 352 which is substantially rounded or curved, and which is shaped and dimensioned to be at least partially received in a substantially rounded inclination-adjusting cavity 254 formed in the inner surface 202 of the ground-securing member 200, and more specifically in the inner surface of the peripheral wall 224, proximal the upper edge 226.

In the illustrated embodiment, the inclination-adjusting ridges 350 define together a second plane containing the central axis X₂ of the inclination-adjusting member 300 (and the longitudinal axis X of the post 10 when the inclination-adjusting member 300 is mounted thereto or when the inclination-adjusting member is part of the post end portion 12). In the illustrated embodiment, the inclination-adjusting ridges 350 are positioned such that the second plane is substantially perpendicular to the first plane defined by the alignment tabs 340.

It will be understood that the shape and the configuration of the inclination-adjusting member 300, as well as the shape, the configuration, the relative location and the number of the base-mounting members, the outer angular coupling portions, the inclination-adjusting ridges and the alignment tabs thereof can vary from the embodiment shown. For example, referring back to the embodiment illustrated in FIG. 22, the post mounting assembly 3150 includes a inclination-adjusting member 3300 which comprises distortion-limiting tabs 3301 (or distortion-limiting ridges 3301) protruding inwardly from the outer surface thereof (four, in the embodiment shown) extending along substantially an entirety of the height of the inclination-adjusting member 3300. In the embodiment illustrated in FIG. 22, the inclination-adjusting member 3300 further comprises post-contacting tabs 3305 protruding inwardly from an inner surface of the peripheral wall at least partially delimiting the post-receiving cavity. In the illustrated embodiment, the inclination adjusting member 3300 comprises four post-contacting tabs 3305 extending substantially along an entirety of the height of the inclination-adjusting member 3300 to allow the post to be held more solidly in all directions within the post-receiving cavity.

In the illustrated embodiment, the bottom wall 306 is not planar, but is instead curved, as best shown in FIG. 8. Specifically, the bottom wall 306 is curved such that in all inclination configurations of the inclination-adjusting member 300 relative to the ground-securing member 200 (i.e. in all the inclined configurations of the ground securing member and the inclination adjusting member), the bottom wall 306 contacts the ground surface and provides proper support of the post 10 against the ground surface. The bottom wall 306 being curved can also facilitate the manipulation and installation of the post mounting assembly 100 by allowing the bottom wall 306 to simply slide along the ground surface when the post 10 is moved from a first inclination to a second inclination by the user.

As mentioned above, the ground-securing member 200 and the inclination-adjusting member 300 are configurable together in a plurality of inclined configurations in which the post 10 is inclined with respect to the direction perpendicular to the ground surface.

According to another aspect of the disclosure, there is thus provided a method 400 for mounting the post 10 having the post end portion 12 to a ground surface in an inclined direction.

The method according to embodiments of the present disclosure may be carried out with a post mounting assembly 100 as the one described above and as the ones described below.

The method comprises a step of providing an inclination-adjusting member 300 being part of or being mounted to the post end portion 12 and comprising at least one inclination-limiting portion 310. The method further comprises a step of providing a ground-securing member 200 having an inner surface 202 at least partially delimiting an internal securing member cavity 210.

The method comprises a step of securing the ground-securing member 200 to the ground surface and a step of engaging the inclination-adjusting member 300 with the ground-securing member 200 in an inclined configuration in which the post 10 is inclined with respect to the direction perpendicular to the ground surface and the inclination-adjusting member 300 is at least partially received in the internal securing member cavity 210, wherein the inclination-limiting portion 310 abuts against the inner surface 202 of the ground-securing member 200 to maintain an inclination of the post 10 with respect to the ground surface.

It will be understood that the order of these steps may vary depending on the configuration of the post mounting assembly 100. For example, in the embodiment illustrated in FIGS. 1 to 12, the inclination-adjusting member 300 is engaged with the ground-securing member 200 before the ground-securing member 200 is fully secured to the ground surface, as will be further explained below. Alternatively, the ground-securing member 200 or at least part of the ground-securing member 200 could be secured to the ground surface before the inclination-adjusting member 300 is engaged with the ground-securing member 200, as will also be explained below.

In the embodiment illustrated in FIGS. 1 to 12, the method comprises mounting the first and second base-mounting members 320 to the post end portion 12, for the post end portion 12 to be at least partially contained in the post-receiving cavity 302. A lower surface of the post end portion 12 thus abuts against an inner surface of the bottom wall 306 of the inclination-adjusting member 300 and the post end portion 12 is at least partially enclosed in the post-receiving cavity 302.

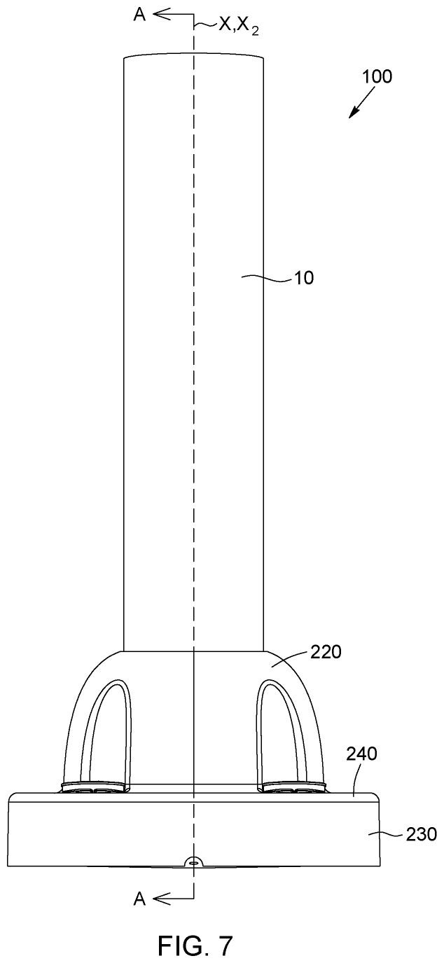

The post end portion 12 with the inclination-adjusting member 300 mounted thereto is then configured in the inclined direction, as represented in FIGS. 7 to 10.

The inclination-adjusting member 300 is then engaged with the ground-securing member 200. In the embodiment shown, the ground-securing member 200 is slid along the post 10 (either before or after the mounting of the inclination-adjusting member 300 to the post end portion 12) until the ground-securing member 200 reaches the post end portion 12 with the inclination-adjusting member 300 mounted thereto. Alternatively, instead of being slid around the post 10, the ground-securing member 200 could be made in two separate halves which could be brought together and secured together around the inclination-adjusting member 300.

The ground-securing member 200 is arranged so that the inclination-adjusting member 300 is at least partially received in the internal securing member cavity 210. The ground-securing member 200 is oriented relative to the inclination-adjusting member 300 such that each alignment tab 340 (or the assembly of the facing alignment tabs of the first and second members) is aligned with a corresponding guiding slot 260 and can be at least partially received into (and slid into) the corresponding guiding slot 260 by further moving the ground-securing member 200 along the post 10 towards the bottom wall 306, in order to ensure that the inclination-adjusting member 300 can only pivot relative to the ground-securing member 200 in a single axis and thus that the teeth members 252 and the coupling grooves 332 engage in the same way on both sides of the inclination-adjusting member 300. The ground-securing member 200 and the inclination-adjusting member 300 are engaged with each other so that the upper ends 352 of the inclination-adjusting ridges 350 are at least partially received in a corresponding one of the substantially rounded inclination-adjusting cavities 254 formed in the inner surface 202 of the ground-securing member 200, as best shown in FIG. 6. The cooperation between the upper ends 352 of the inclination-adjusting ridges 350 and the inclination-adjusting cavities 254 allows pivoting of the ground-securing member 200 with respect to the inclination-adjusting member 300 in the first plane defined by the alignment tabs 340 of the inclination-adjusting member 300. In other words, the ground-securing member 200 and the inclination-adjusting member 300 are pivotable with respect to each other about a pivot axis defined by the upper ends 352 of the inclination-adjusting ridges 350 (about a pivot axis substantially perpendicular to the first plane defined by the alignment tabs 340).

The pivoting of the inclination-adjusting member 300 with respect to the ground-securing member 200 allows adjusting the inclination of the post 10 with respect to the direction perpendicular to the ground surface to which the ground-securing member 200 is to be secured. It will be understood that when pivoting the inclination-adjusting member 300 with respect to the ground-securing member 200, the teeth members 252 are not engaged with the coupling grooves 332. Instead, because of the angled configuration of the teeth members 252 and of the coupling portion outer face 331 relative to the central axes X₁, X₂ of the ground-securing and inclination-adjusting members 200, 300, the ground-securing member 200 could be maintained in a position in which the teeth members 252 are spaced apart (for instance slightly above) from the coupling grooves 332 but in which the upper ends 352 of the inclination-adjusting ridges 350 are still engaged in the inclination-adjusting cavities 254. In this position, the inclination-adjusting member 300 could be pivoted with respect to the ground-securing member 200 until the desired inclination configuration is reached.

In the illustrated embodiment, the inner and outer angular coupling portions 250, 330 are fully engaged with each other when the inclination-adjusting member 300 is engaged with the ground-securing member 200 in the desired inclined configuration. Specifically, from the position described above, the ground-securing member 200 could then be slightly lowered such that at least one of the teeth members 252 engages or at least partially engages one or more of the coupling grooves 332 to thereby lock the ground-securing member 200 and the inclination-adjusting member 300 together in the desired inclined configuration.

In some inclined configurations, when the inclination-adjusting member 300 is engaged with the ground-securing member 200, the inclination-limiting portion 310 of the inclination-adjusting member 300 abuts the inner surface 202 of the ground-securing member 200 to maintain the inclination of the post 10 with respect to the ground surface. It will be understood that this corresponds to a maximum inclination of the post 10 relative to the ground surface. In other inclined configurations, the inclination-limiting portion 310 may not abut the inner surface 202 of the ground-securing member 200.

As explained above, the inner and outer angular coupling portions 250, 330 are engageable with each other in a plurality of angular positions to allow the configuration of the ground-securing member 200 and the inclination-adjusting member 300 in a plurality of inclined configurations (i.e. to allow the configuration of the post 10 in a plurality of inclined configurations with respect to the direction perpendicular to the ground surface).

It will be understood that the shape, number and dimensions of the outer and inner angular coupling portions 330, 250 can be modified to allow more or less different angular positions therebetween.

Moreover, in the embodiment shown in FIG. 22, the distortion-limiting tabs 3201, 3301 are shaped and dimensioned to cooperate together so as to mitigate a distortion of the inclination-adjusting member 3300 when all the components are assembled together and when the ground-securing member 3200 is secured to the ground surface.

In the illustrated embodiment, the securing of the ground-securing member 200 to the ground surface comprises engaging mechanical fasteners 102 (shown in FIG. 1) in the fastener-receiving through hole 209 formed in the ground-securing member 200 and in the ground surface. It will therefore be understood that a contact between the post mounting assembly 100 and the ground surface is provided at least partially by the ground-securing surface 204 of the ground-securing member 200 and the ground-contacting surface 306 (or bottom wall 306) of the inclination-adjusting member 300. The bottom wall 306 might be at least partially formed in a material having flexibility properties allowing to increase the contact of the bottom wall 306 with the ground surface even when the central axis X₂ of the inclination-adjusting member 300 is inclined with respect to the direction perpendicular to the ground surface, thus increasing a stability of the mounting of the post 10 to the ground surface, besides the contact with the ground surface allowed by the curved profile of the bottom wall 306.

It will be understood that the shape and the configuration of the post mounting assembly 100, and the relative arrangements, shapes and dimensions of the different components thereof, can vary from the embodiment shown.

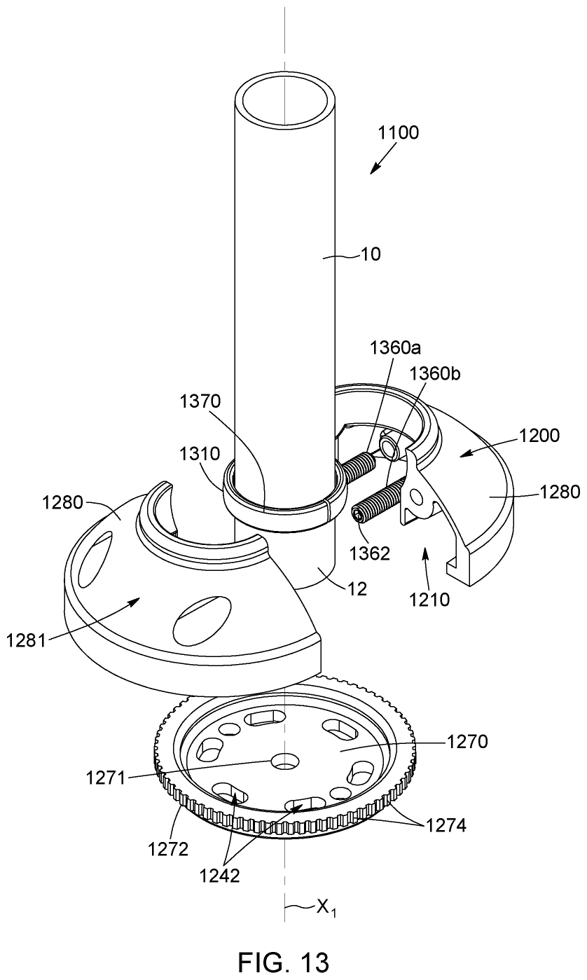

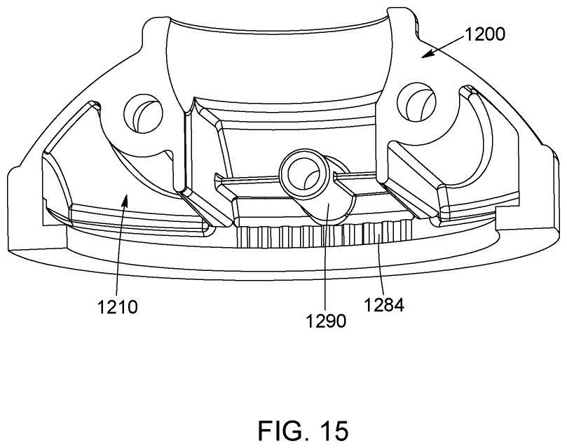

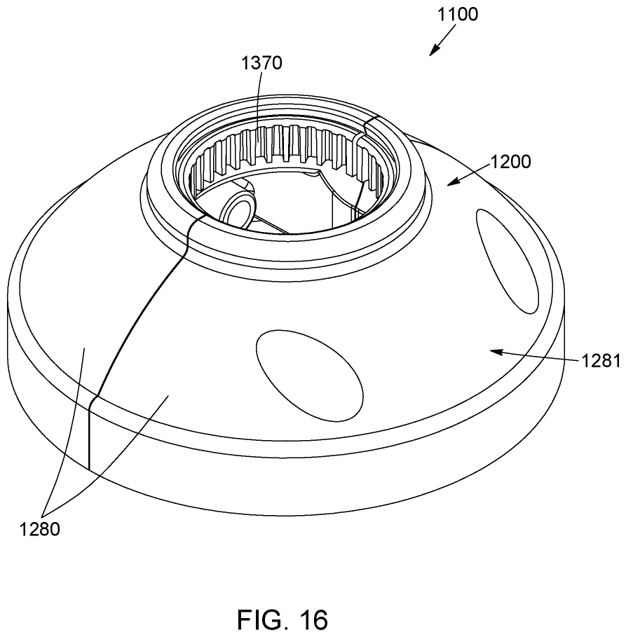

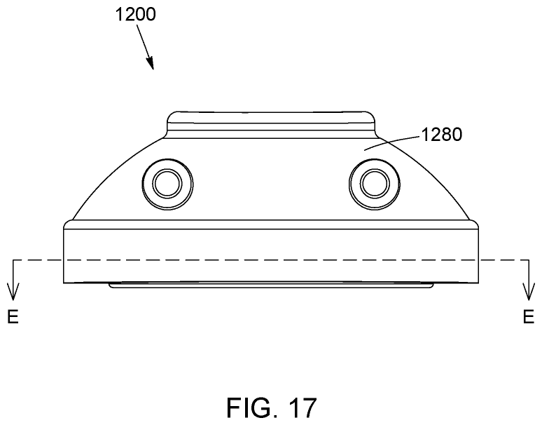

Referring to FIGS. 13 to 18B, there is shown a post mounting assembly 1100, in accordance with another embodiment.

Similarly to the embodiment illustrated in FIGS. 1 to 12, the post mounting assembly 1100 comprises a ground-securing member 1200 securable to the ground surface and having an inner surface 1202 at least partially delimiting an internal securing member cavity 1210, and an inclination-adjusting member 1300 being part of or being mounted to the post end portion 12 and selectively engageable with the ground-securing member 1200, the inclination-adjusting member 1300 comprising at least one inclination-limiting portion 1310. The ground-securing member 1200 and the inclination-adjusting member 1300 are configurable together in at least one inclined configuration in which the post 10 is inclined with respect to a direction perpendicular to the ground surface, wherein the inclination-limiting portion 1310 abuts the inner surface 1202 of the ground-securing member 1200 to maintain an inclination of the post 10 with respect to the ground surface.

In the illustrated embodiment, the ground-securing member 1200 comprises a ground-securing disc 1270 with fastener-receiving holes 1242 formed therein which are shaped and dimensioned to receive fasteners for securing the ground-securing member 1200 (and more particularly the ground-securing disc 1270 thereof) to the ground surface.

The ground-securing disc 1270 also comprises a peripheral wall 1272 (or peripheral rim 1272) with a plurality of angular couplers 1274 formed on an outer surface thereof and extending outwardly from the peripheral wall 1272. In the illustrated embodiment, the angular couplers 1274 comprise a plurality of angular coupling ribs or teeth substantially parallel to each other and extending along a central axis X₁ of the ground-securing member 1200. In the illustrated embodiment, the central axis X₁ intersects a center 1271 of the ground-securing disc 1270.

In the illustrated embodiment, the ground-securing member 1200 further comprises a cap assembly 1281 comprising first and second cap members 1280 removably couplable to each other (for instance via mechanical fasteners engaging together the first and second cap members 1280).

The cap assembly 1281 (the first and second cap members 1280 thereof, in the embodiment shown) and the ground-securing disc 1270 at least partially delimit together the internal securing member cavity 1210.

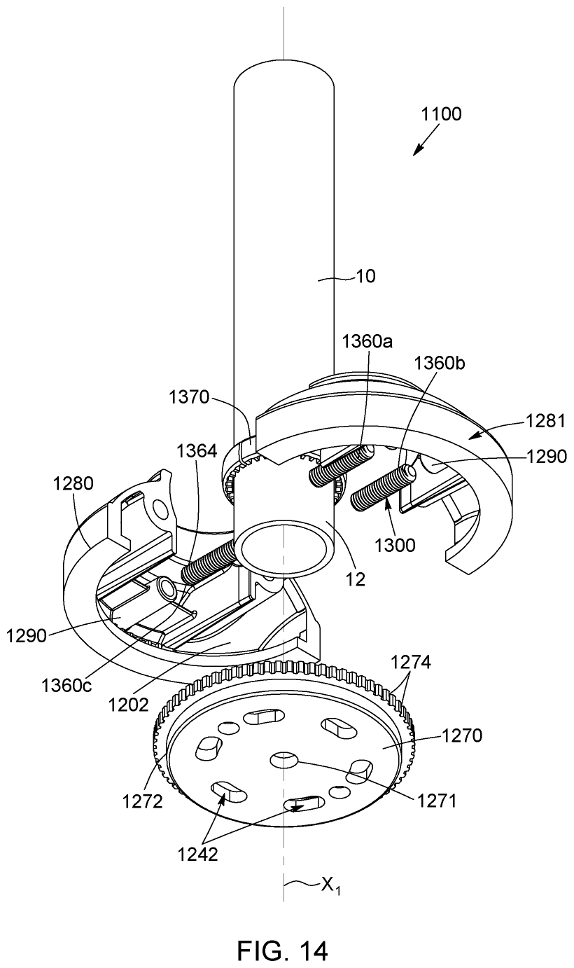

As best shown in FIGS. 13 and 14, the cap assembly 1281 is shaped and dimensioned to at least partially contain and at least partially cover the inclination-adjusting member 1300.

The ground-securing member 1200 further comprises at least one adjusting pin-receiving sleeve 1290, and more specifically three adjusting pin-receiving sleeves 1290 in the embodiment shown, protruding inwardly (with respect to the internal securing member cavity 1210) from the inner surface 1202 thereof, and more specifically, from an inner surface of the cap assembly 1281 in the embodiment shown.

The inner surface of the cap assembly 1281 also comprises angular couplers 1284 formed therein which extend inwardly into an interior of the cap assembly 1281 and which are sized and shaped to be engaged with the angular couplers 1274 of the ground-securing disc 1270. The angular couplers of the cap assembly 1281 and the ground-securing disc 1270 are shaped and dimensioned to engage the cap assembly and the ground-securing disc in a plurality of angular positions with respect to each other.

It will be understood that the shape and the configuration of the ground-securing member 1200, as well as the shape, the configuration, the relative location and the number of the cap members 1280, the ground-securing disc 1270 and the adjusting pin-receiving sleeves 1290 thereof can vary from the embodiment shown.

In the illustrated embodiment, the inclination-adjusting member 1300 is made of multiple components. Specifically, the inclination-adjusting member 1300 comprises at least one post-engaging pin 1360—or adjustable fastener 1360, or inclination-adjusting pin 1360 (three, in the embodiment shown)—having a first end 1362 engageable with (for instance abuttable against) an outer surface of the post end portion 12 and a second end 1364 couplable with the ground-securing member 1200 and selectively mountable to a corresponding one of the pin-receiving sleeves 1290 in at least one linear position when the ground-securing member 1200 and the inclination-adjusting member 1300 are configured together in the above-mentioned inclined configuration. In the illustrated embodiment, the inclination-adjusting pins 1360 include first and second inclination-adjusting pins 1360a, 1360b configured for engaging the post end portion 12 on a first side and a third inclination inclination-adjusting pin 1360c configured for engaging the post end portion 12 on a second side opposite the first side. Still in the embodiment shown, the first, second and third pins 1360a, 1360b, 1360c are all substantially parallel to each other and all extend substantially in a common horizontal plane. Alternatively, the first, second and third pins 1360a, 1360b, 1360c could extend along non-parallel axes and/or could extend in different horizontal planes. In another embodiment, the pins 1360 could include more or less than three pins.

The post-engaging pin 1360 are movable along their longitudinal axis to selectively retract and extend the post-engaging pin 1360 relative to the corresponding pin-receiving sleeve 1290. In the illustrated embodiment, each post engaging pin 1360 is threaded and is threadably engageable in the corresponding pin-receiving sleeve 1290, such that turning the post engaging pin 1360 about its longitudinal axis will selectively retract and extend the post-engaging pin 1360 relative to the corresponding pin-receiving sleeve 1290. Alternatively, the post-engaging pins 1360 may not be threaded and may instead slidably engage the corresponding pin-receiving sleeves 1290, or may be configured according to any other suitable configuration that would allow the post-engaging pins 1360 to be moved longitudinally.

In the illustrated embodiment, the inclination-adjusting member 1300 also comprises an inclination-limiting ring 1370 forming at least partially the inclination-limiting portion 1310. As best shown in FIGS. 13 and 14, the inclination-limiting ring 1370 is mounted to the post end portion 12. As represented in FIG. 16, the inclination-limiting ring 1370 has a corrugated inner surface to limit the risk of the inclination-limiting ring 1370 sliding along the post 10 and/or to facilitate the fabrication of the ring 1370.

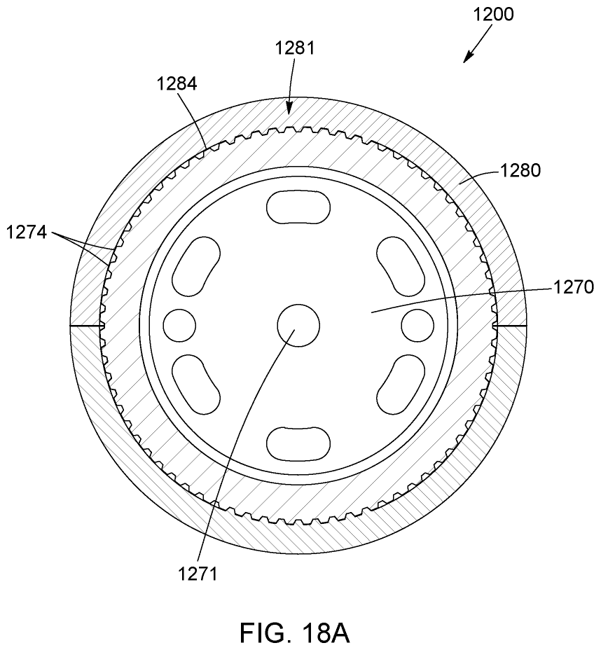

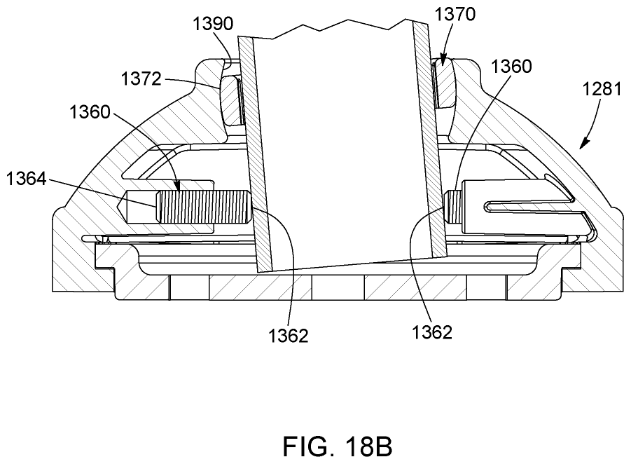

In illustrated embodiment, the inclination-limiting ring 1370 has a curved outer face 1372 which has the same curvature as a curved inner face portion 1290 of the cap assembly 1281 located near the top of the cap assembly 1281, as shown in FIG. 18B. It will be understood that this configuration forms a spherical bearing arrangement such that, when the post end portion 12 is received in the internal securing member cavity 1210, the post 10 is held at the top of the ground-securing member 1200 while the post end portion 12 located below the top of the ground-securing member 1200 may be held by the inclination-adjusting pins 1360 at a position which is laterally offset relative to the inclination-limiting ring 1370 to thereby incline the post 10.

In another embodiment, the inclination-limiting ring 1370 could instead be part of the post end portion 12. The inclination-limiting ring 1370 can be made of a single, unitary piece, or could comprise a plurality of connectable ring portions to surround at least partially the post end portion 12.

It will be understood that the shape and the configuration of the inclination-adjusting member 1300, as well as the shape, the configuration, the relative location and/or the number of the inclination-limiting ring and the post-engaging pins thereof can vary from the embodiment shown.

Similarly to the embodiment illustrated in FIGS. 1 to 12, the ground-securing member 1100 allows the mounting of the post end portion 12 to the ground surface in at least one inclined direction (in a plurality of inclined configurations, in the illustrated embodiment).

The method comprises a step of securing the ground-securing disc 1270 to the ground surface. The method also comprises engaging the first end 1362 of the post-engaging pins 1360 in a corresponding one of the pin-receiving sleeves 1290. In the embodiment shown, screwing the first end 1362 in and/or unscrewing the first end 1362 from a pin-receiving hole formed in the pin-receiving sleeve allows adjusting a position of the first end 1362 of the post-engaging pins 1360. In other words, by screwing or unscrewing the post-engaging pins 1360 in and/or out of the corresponding pin-receiving sleeve, the length by which the post-engaging pins 1360 extends out of the corresponding pin-receiving sleeve can be adjusted.

The first ends 1362 of the different post-engaging pins 1360 are positioned to at least partially define therebetween a post receiving channel which is sized and shaped to receive and hold the post end portion 12. In other words, the post-engaging pins 1360 are engaged with the ground-securing member 1200 so that dimensions of the post receiving channel correspond substantially to dimensions of the portion of the post end portion 12 received therein (to an outer diameter of the portion of the post end portion 12, in the embodiment shown), so that the post end portion 12 is substantially held via the cooperation of the ground-securing member 1200 and the inclination-adjusting member 1300. As explained above, depending on the length by which the pins 1360 extend out of their respective pin-receiving sleeves 1290, the lower end of the post end portion 12 can be laterally offset relative to the portion of the post 10 held in the inclination-limiting ring 1370 to a desired position which would angle the post 10 to a desired inclination with respect to the direction perpendicular to the ground surface.

The method further comprises coupling the first and second cap members 1280 and the ground-securing disc 1270 to enclose at least partially the post end portion 12. The method also comprises a step of securing together the first and second cap members 1280 of the cap assembly 1281 around the post end portion 12.

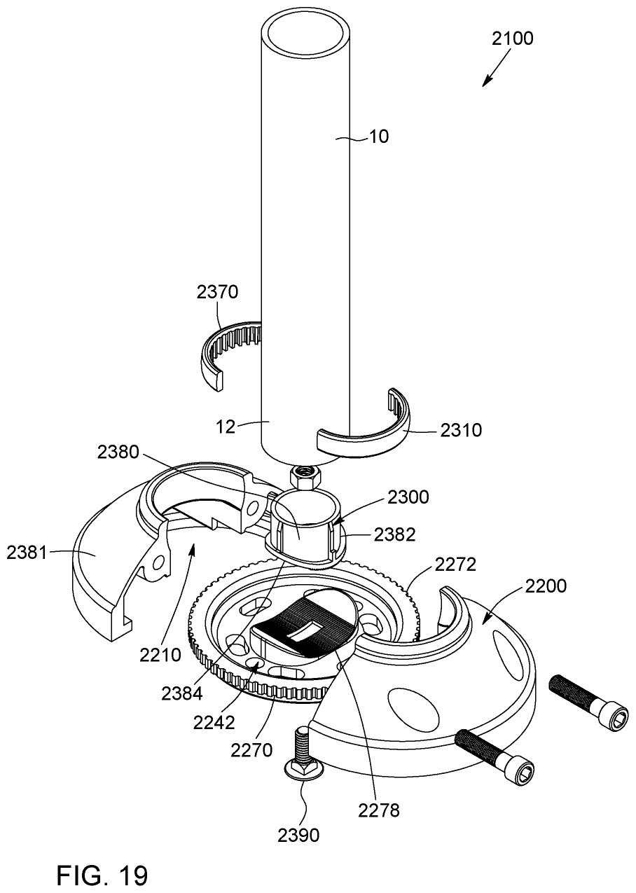

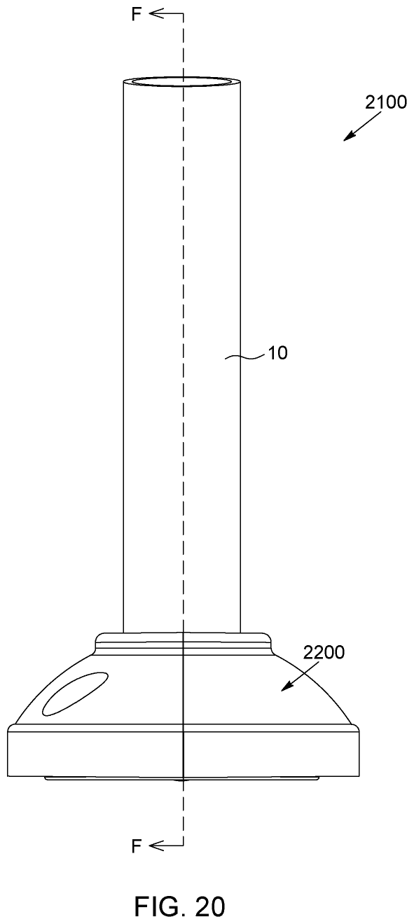

Referring now to FIGS. 19 to 21, there is shown a post mounting assembly 2100, in accordance with another embodiment.

Similarly to the embodiments described above, the post mounting assembly 2100 comprises a ground-securing member 2200 securable to the ground surface and having an inner surface 2202 at least partially delimiting an internal securing member cavity 2210, and an inclination-adjusting member 2300 being part of or being mounted to the post end portion 12 and selectively engageable with the ground-securing member 2200, the inclination-adjusting member 2300 comprising at least one inclination-limiting portion 2310. The ground-securing member 2200 and the inclination-adjusting member 2300 are configurable together in at least one inclined configuration in which the post 10 is inclined with respect to a direction perpendicular to the ground surface, wherein the inclination-limiting portion 2310 abuts the inner surface 2202 of the ground-securing member 2200 to maintain an inclination of the post 10 with respect to the ground surface.

In the illustrated embodiment, the ground-securing member 2200 comprises a ground-securing disc 2270 and a cap assembly 2281 comprising first and second cap members 2280. The ground-securing disc 2270 also has fastener-receiving holes 2242 formed therein and a peripheral wall 2272 with angular couplers formed on an outer surface thereof.

In the illustrated embodiment, the ground-securing disc 2270 has a ground-facing side 2271 and an opposed post-facing side 2276 (or top surface 2276). The ground-securing disc 2270 further includes an inner angular coupling portion 2278 formed in the post-facing side 2276. Specifically, the inner angular coupling portion 2278 includes one or more pivot-limiting tooth 2282 which is engageable with a corresponding portion of the inclination-adjusting member 2300 to set the inclination-adjusting member 2300 to a corresponding configuration relative to the ground-securing member 2200.

Similarly to the embodiment illustrated in FIGS. 13 to 18, the cap assembly 2281 is shaped and dimensioned to at least partially cover the inclination-adjusting member 2300. In other words, the internal securing member cavity 2210 is at least partially delimited by the cap assembly 2281 and the ground-securing member 2270, and is shaped and dimensioned to at least partially contain the inclination-adjusting member 2300. The inner surface 2202 of the ground-securing member 2200 further has angular couplers formed therein engageable with the angular couplers of the ground-securing disc 2270.

It will be understood that the shape and the configuration of the ground-securing member 2200, as well as the shape, the configuration, the relative location and/or the number of the cap members 2280, the ground-securing disc 2270 and the inner angular coupling portion thereof can vary from the embodiment shown.

In the illustrated embodiment, the inclination-adjusting member 2300 comprises an outer surface 2308 with at least one pivot-limiting tooth 2309 formed thereon. Specifically, the inclination-adjusting member 2300 comprises a post bottom cap 2380 snuggly engageable within the post end portion 12, the post bottom cap 2380 comprising a post-engaging portion 2382 and an inclination-maintaining portion 2384 extending downwardly from the post end portion 12 when engaged therewith.

In the illustrated embodiment, in a plane comprising the longitudinal axis X of the post 10 (and the central axis X₂ of the inclination-adjusting member 2300), the inclination-maintaining portion 2384 is curved convexly towards the ground surface, whereas the inner angular coupling portion 2278 of the ground-securing disc 2270 is similarly curved convexly.

The inclination-maintaining portion 2384 (comprising the pivot-limiting teeth 2309) of the inclination-adjusting member 2300 and the inner angular coupling portion of the ground-securing member 2200 are shaped and dimensioned to be couplable to each other (i.e. engageable with each other) in at least one angular position when the ground-securing member 2200 and the inclination-adjusting member 2300 are configured together in the inclined configuration. Specifically, in the illustrated embodiment, the pivot-limiting teeth 2282 of the ground-securing member 2200 are engageable with the pivot-limiting teeth 2309 of the inclination-adjusting member 2300 to set the inclination-adjusting member 2300 to a corresponding inclination relative to the ground-securing member 2200. Alternatively, the inclination-maintaining portion 2384 and the inner angular coupling portion 2278 of the ground-securing disc 2270 could instead both include substantially rough surfaces which would hold the inclination-adjusting member 2300 relative to the ground-securing member 2200 by friction.

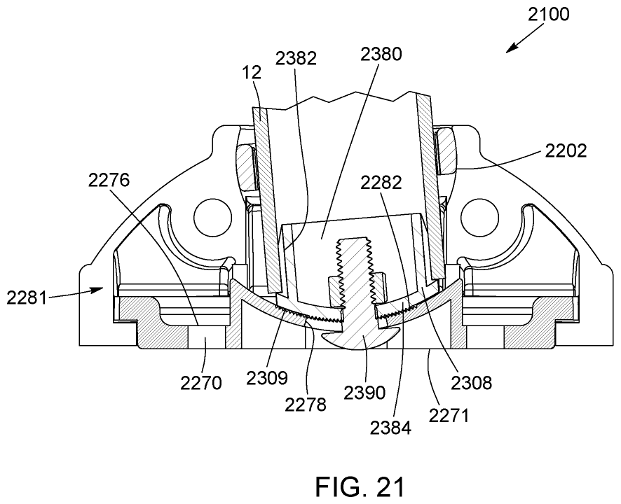

Similarly to the embodiment illustrated on FIGS. 13 to 18, the inclination-adjusting member 2300 comprises an inclination-limiting ring 2370 forming at least partially the inclination-limiting portion 2310. As best shown in FIG. 21, the inclination-limiting ring 2370 is mounted to the post end portion 12. As represented in FIG. 19, the inclination-limiting ring 2370 also has a corrugated inner surface. It could also be conceived an inclination-limiting ring 2370 which would be part of the post end portion 12. The inclination-limiting ring 2370 can be made of two distinct pieces, as in the embodiment shown, or could comprise one or more than two connectable ring portions to surround at least partially the post end portion 12.

The inclination-adjusting member 2300 further comprises an inclination-limiting fastener 2390 engageable with the ground-securing member 2200 (for instance with the ground-securing member 2270 thereof) and the inclination-limiting portion 2384 (with the post bottom cap 2380, in the embodiment shown) to further maintain the ground-securing member and the inclination-adjusting member in the inclined configuration. Specifically, the inclination-limiting fastener 2390 is slidably insertable through an elongated slot 2290 defined in the inner angular coupling portion 2278 of the ground-securing disc 2270. This configuration allows the elongated slot 2290 to allow the inclination-adjusting member 2300 to pivot relative to the ground-securing member 2200 while restricting the pivoting of the inclination-adjusting member 2300 to a single vertical plane extending longitudinally through the elongated slot 2290. Once the inclination-adjusting member 2300 is set to a desired position relative to the ground-securing member 2200, the inclination-limiting fastener 2390 could be tightened to press the inclination-maintaining portion 2384 against the inner angular coupling portion 2278 of the ground-securing disc 2270 in order to prevent movement of the inclination-adjusting member 2300 relative to the ground-securing member 2200.

It will be understood that the shape and the configuration of the inclination-adjusting member 2300, as well as the shape, the configuration, the relative location and/or the number of the inclination-limiting ring, the inclination-maintaining portion and the inclination-limiting fastener thereof can vary from the embodiment shown.

Similarly to the embodiments described above, the ground-securing member 2100 allows the mounting of the post end portion 12 to the ground surface in at least one inclined configuration (in a plurality of inclined configurations, in the embodiment shown).

The method comprises a step of securing the ground-securing disc 2270 to the ground surface, the inclination-limiting fastener being engaged therewith from the ground-facing side thereof. The method also comprises arranging the post end portion 12 with the post bottom cap 2380 mounted thereto in the desired inclined configuration with respect to the direction perpendicular to the ground surface. The method then comprises engaging the post bottom cap 2380 with the ground-securing disc 2270, the inclination-limiting fastener being engaged with the post bottom cap 2380.

The method further comprises mounting the inclination-limiting ring 2270 to the post end portion 12 and coupling the first and second cap members 2280 and the ground-securing disc 2270 to enclose at least partially the post end portion 12. The method also comprises a step of securing together the first and second cap members 2280 of the cap assembly 2281 around the post end portion 12.

It will be understood that the above post mounting assembly can be part of a broader support assembly which could be used for supporting any structure, such as a handrail, a sign or the like, above a ground surface. The support assembly could include a post and a post mounting assembly in accordance with any one of the embodiments described above. In another embodiment, the support assembly could include a plurality of posts and a plurality of post mounting assemblies in accordance with any one of the embodiments described above.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A post mounting assembly for mounting a post to a ground surface, the post mounting assembly comprising:
a ground-securing member securable to the ground surface and having an inner surface at least partially delimiting an internal securing member cavity; and
an inclination-adjusting member mountable to the post, the inclination-adjusting member comprising at least one inclination limiting portion receivable in the internal securing member cavity, the inclination-adjusting member being selectively engageable with the ground securing member such that the ground securing member and the inclination adjusting member are configured together in at least one inclined configuration in which the post is inclined with respect to a direction perpendicular to the ground surface at a corresponding inclination, the at least one inclination limiting portion abutting the inner surface of the ground securing member when the ground securing member and the inclination adjusting member are configured in one of the at least one inclined configuration to maintain the post at the corresponding inclination relative to the ground surface.

2. The post mounting assembly as claimed in claim 1, wherein the at least one inclined configuration includes a plurality of inclined configurations, each inclined configuration corresponding to an inclination relative to the ground surface.

3. The post mounting assembly as claimed in claim 2, wherein the ground securing member comprises at least one inner angular coupling portion located on the inner surface thereof and wherein the inclination-adjusting member comprises an outer surface with at least one outer angular coupling portion, the inner and outer angular coupling portions being engageable with each other in at least one angular position when the ground securing member and the inclination adjusting member are configured together in said at least one inclined configuration.

4. (canceled)

5. (canceled)

6. The post mounting assembly as claimed in claim 3, wherein each inner angular coupling portion comprises a plurality of teeth members and wherein each outer angular coupling portion comprises a plurality of coupling grooves for receiving a corresponding plurality of the teeth members.

7. (canceled)

8. (canceled)

9. (canceled)

10. (canceled)

11. (canceled)

12. (canceled)

13. (canceled)

14. The post mounting assembly as claimed in claim 3, wherein the ground securing member further comprises at least one guiding slot formed in the inner surface and wherein the inclination-adjusting member further comprises at least one alignment tab, each alignment tab being receivable in a corresponding one of the at least one guiding slots.

15. (canceled)

16. (canceled)

17. (canceled)

18. (canceled)

19. The post mounting assembly as claimed in claim 14, wherein each guiding slot is at least partially delimited by two guiding walls extending from the inner surface of the ground-securing member inwardly into the internal securing member cavity and extending substantially parallel to each other.

20. The post mounting assembly as claimed in claim 3, wherein each inner angular coupling portion includes a coupling portion outer face that is inclined relative to a central axis of the inclination-adjusting member such that a bottom end of the coupling portion outer face is located at a greater distance from the central axis than a top end of the coupling portion outer face.

21. (canceled)

22. (canceled)

23. (canceled)

24. The post mounting assembly as claimed in claim 3, wherein the ground securing member is made of a single, unitary piece.

25. The post mounting assembly as claimed in claim 3, wherein the ground securing member is sized and shaped to entirely cover the inclination-adjusting member when the inclination-adjusting member is received in the ground-securing member.

26. (canceled)

27. The post mounting assembly as claimed in claim 2, wherein the ground-securing member comprises at least one adjusting pin receiving sleeve protruding inwardly from the inner surface, and wherein the inclination-adjusting member comprises at least one post engaging pin, each post engaging pin having a first end engageable with an outer surface of the post and a second end selectively engageable in a corresponding one of the pin receiving sleeve in at least one linear position when the ground securing member and the inclination adjusting member are configured together in said at least one inclined configuration.

28. The post mounting assembly as claimed in claim 27, wherein the ground-securing member comprises a ground-securing disc and a cap assembly engageable with the ground-securing disc to set the cap assembly in one of a plurality of angular positions relative to the ground-securing disc.

29. The post mounting assembly as claimed in claim 28, wherein the ground-securing disc includes a peripheral wall and a plurality of angular couplers extending outwardly from the peripheral wall, and wherein the cap assembly including a plurality of angular couplers extending inwardly into an interior of the cap assembly, the angular couplers of the ground-securing disc and the angular couplers of the cap assembly being sized and shaped to be engaged with each other.

30. (canceled)

31. (canceled)

32. (canceled)

33. (canceled)

34. The post mounting assembly as claimed in claim 27, wherein each post engaging pin is movable along a longitudinal axis thereof to selectively retract and extend the post engaging pin relative to the corresponding pin-receiving sleeve.

35. The post mounting assembly as claimed in claim 34, wherein each post engaging pin is threaded and is threadably engageable in the corresponding pin-receiving sleeve.

36. The post mounting assembly as claimed in claim 27, wherein the ground-securing member includes a curved inner face portion and wherein the inclination-adjusting member further comprises an inclination-limiting ring mountable to a post end portion of the post, the inclination-limiting ring being receivable in the curved inner face portion and having a curved outer face conforming with the curved inner face portion.

37. (canceled)

38. The post mounting assembly as claimed in claim 2, wherein the ground-securing member comprises a ground-facing side, an opposed post-facing side and at least one inner angular coupling portion arranged on the post-facing side, and further wherein the inclination-adjusting member comprises an outer surface with an outer angular coupling portion formed thereon, the inner and outer angular coupling portions being engageable with each other in at least one angular configuration when the ground securing member and the inclination adjusting member are configured together in said at least one inclined configuration.

39. The post mounting assembly as claimed in claim 38, wherein the ground-securing member comprises a ground-securing disc and a cap assembly engageable with the ground-securing disc to set the cap assembly in one of a plurality of angular positions relative to the ground-securing disc.

40. The post mounting assembly as claimed in claim 39, wherein the ground-securing disc includes a peripheral wall and a plurality of angular couplers extending outwardly from the peripheral wall, and wherein the cap assembly including a plurality of angular couplers extending inwardly into an interior of the cap assembly, the angular couplers of the ground-securing disc and the angular couplers of the cap assembly being sized and shaped to be engaged with each other.

41. The post mounting assembly as claimed in claim 38, wherein the outer angular coupling portion includes at least one pivot-limiting tooth and wherein the inner angular coupling portion includes at least one corresponding pivot-limiting tooth engageable with the at least one pivot-limiting tooth of the outer angular coupling portion.

42. (canceled)

43. (canceled)

44. (canceled)

45. (canceled)

46. A method for securing a post to a ground surface in an inclined configuration, the method comprising:
providing an inclination adjusting member engageable with a post end portion of the post and comprising at least one inclination limiting portion;
providing a ground securing member having an inner surface at least partially delimiting an internal securing member cavity;
securing the ground-securing member to the ground surface;
engaging the inclination adjusting member with the ground securing member in an inclined configuration in which the post is inclined with respect to a direction perpendicular to the ground surface and the inclination adjusting member is at least partially received in the internal securing member cavity, wherein said at least one inclination-limiting portion abuts against the inner surface of the ground-securing member to maintain an inclination of the post with respect to the ground surface.
